(19) United States
(12) Patent Application Publication
(10) Pub. No.: US 2015/0294239 A1
(43) Pub. Date: Oct. 15, 2015

(54) SYSTEMS, METHODS AND APPARATUS FOR ONLINE MANAGEMENT OF A TRAVEL ITINERARY

(71) Applicants: Madelein Constanza ARAYA HERNANDEZ, PUNTA ARENAS (CL); Manuel AGUILA YANEZ, PUNTA ARENAS (CL); Benjamin Sebastian Ariel DIAZ CABALLERO, VINA DEL MAR (CL); Michael Harald HAASE, KOELN (DE); Johannes HEBBELMANN, PAPENBURG (DE); Danny Enrique PERICH LARA, VINA DEL MAR (CL); Fabian Leonardo PERICH LARA, VINA DEL MAR (CL); Oliver SCHROEDER, BREMEN (DE); David STAUFFER, VINA DEL MAR (CL); Justus Fritz ZEPPENFELD, WORPSWEDE (DE)

(72) Inventors: Madelein Constanza ARAYA HERNANDEZ, PUNTA ARENAS (CL); Manuel AGUILA YANEZ, PUNTA ARENAS (CL); Benjamin Sebastian Ariel DIAZ CABALLERO, VINA DEL MAR (CL); Michael Harald HAASE, KOELN (DE); Johannes HEBBELMANN, PAPENBURG (DE); Danny Enrique PERICH LARA, VINA DEL MAR (CL); Fabian Leonardo PERICH LARA, VINA DEL MAR (CL); Oliver SCHROEDER, BREMEN (DE); David STAUFFER, VINA DEL MAR (CL); Justus Fritz ZEPPENFELD, WORPSWEDE (DE)

(21) Appl. No.: 14/251,150

(22) Filed: Apr. 11, 2014

(51) Int. Cl. G06Q 10/02

(52) U.S. Cl. CPC G06Q 10/025

(57) ABSTRACT

A first itinerary comprising a first plurality of first location elements associated with locations to be visited during a trip, each first location element comprising first duration information, first arrival date information, and first departure date information, is maintained. A second itinerary comprising a plurality of transport elements associated with transportation to be used during the trip and a second plurality of second location elements, each second location element associated with a corresponding first location element, each second location element comprising second duration information, second arrival date information, and second departure date information is maintained. Modification information indicating that a duration specified in a selected first location element has been altered is received. A first duration, first arrival date information, or first departure date information in a first location element is adjusted based on the modification information. Flight information relating to an airline flight is received. A second duration information or a second arrival date information in a second location element is adjusted based on the flight information.

### TECHNICAL FIELD

This specification relates generally to systems and methods for managing a travel itinerary, and more particularly to systems and methods for online management of a travel itinerary.

### BACKGROUND

Existing systems and methods for constructing and maintaining a travel itinerary are time-consuming and require a significant amount of hands-on data input and data manipulation. In many existing systems, a travel schedule must be entered manually into a database; subsequently, each time a change is made to any date within the schedule, human input is required to examine other dates in the schedule to ensure that all dates are synchronized. In addition, separate systems are used for overall scheduling of a trip, for booking airline tickets, for booking hotels, for scheduling tours and events at various localities, etc. These separate systems operate independently and are not easily integrated. Any attempt to consolidate information from these systems requires substantial and continuous human effort. For example, it is often necessary for a user to retrieve data from a flight reservation system and re-enter it into a scheduling database, to retrieve data from a hotel reservation system and re-enter it into the scheduling database, etc.

### SUMMARY

In accordance with an embodiment, a method of managing a travel itinerary for a trip is provided. Information indicating a first location at which a traveler is to start the trip, a second location at which the traveler is to end the trip, a start date on which the trip is to begin, a plurality of intermediate locations which the traveler is to visit during the trip, an order in which the intermediate locations are to be visited, and a plurality of intermediate location durations indicating how many nights the traveler is to spend in each respective intermediate location, are received from a user. In one embodiment, no dates associated with the intermediate locations are received from the user. A start element associated with the first location is generated, wherein the start element comprises a dateout value. An end element associated with the second location is generated, wherein the end element comprises a datein value. For each intermediate location, a respective intermediate element comprising a datein value indicating a date when the user is to arrive at the respective location, a dateout value indicating a date when the user is to depart from the respective location, and a duration value indicating how many nights the user is to spend at the respective location, is generated. A plurality of modifications to the itinerary is received from one or more users. For each modification, the intermediate elements are examined in succession, and a series of operations are performed with respect to each respective intermediate element. The series of operations comprises updating the datein value of the respective intermediate element based on the dateout value of a preceding element, wherein the start element precedes a first intermediate element, and updating the dateout value of the respective intermediate element based on the duration value of the respective element.

In one embodiment, the plurality of modifications comprises one of a change to a duration value of a selected intermediate element, a removal of a selected intermediate element, and an addition of a second intermediate element.

In another embodiment, a trip itinerary comprising the start element, the end element and the plurality of intermediate elements is generated. In one embodiment, the trip itinerary is displayed visually on a display.

In another embodiment, each of the start element and the end element, and each intermediate element is an object in an object-oriented programming architecture.

In another embodiment, second information relating to a transport component (such as an airline flight) associated with the trip is received. A transport element associated with the transport component is generated, wherein the transport element comprises a datein value, a dateout value, and a duration value. A transport itinerary comprising a second plurality of location elements corresponding to the intermediate elements, and the transport element, is generated.

In one embodiment, a duration value and a datein value of a location element are adjusted based on the duration value of the transport element.

In another embodiment, the plurality of modifications comprises a first modification and a second modification, and the method further comprises receiving a first modification from a first user device via a network, and receiving a second modification from a second user device, via the network.

In accordance with another embodiment, a system comprises a memory for storing start elements, end elements and intermediate elements in one or more itineraries, and one or more processors. The one or more processors are adapted to receive from a user information indicating a first location at which a traveler is to start the trip, a second location at which the traveler is to end the trip, a start date on which the trip is to begin, a plurality of intermediate locations which the traveler is to visit during the trip, an order in which the intermediate locations are to be visited, and a plurality of intermediate location durations indicating how many nights the traveler is to spend in each respective intermediate location, without receiving from the user dates associated with the intermediate locations. The one or more processors are further adapted to generate an itinerary comprising a start element associated with the first location, the start element comprising a dateout value, and an end element associated with the second location, the end element comprising a datein value, and, for each intermediate location, generate a respective intermediate element comprising a datein value indicating a date when the user is to arrive at the corresponding location, a dateout value indicating a date when the user is to depart from the corresponding location, and a duration value indicating how many nights the user is to spend at the corresponding location. The one or more processors are also adapted to receive a plurality of modifications to the itinerary from one or more users, and, for each modification, examine the intermediate elements in succession and perform a series of operations with respect to each respective intermediate element. The series of operations comprises updating the datein value of the respective intermediate element based on the dateout value of a preceding element, wherein the start element precedes a first intermediate element, and updating the dateout value of the respective intermediate element based on the duration value of the respective element.

In accordance with another embodiment, a method of managing an itinerary is provided. A first itinerary comprising a first plurality of first location elements associated with locations to be visited during a trip, each first location element comprising first duration information, first datein information, and first dateout information, is maintained. A second itinerary comprising a plurality of transport elements associated with transportation to be used during the trip and a second plurality of second location elements, each second location element associated with a corresponding first location element, each second location element comprising second duration information, second datein information, and second dateout information, is maintained. Modification information indicating that a duration specified in a selected first location element has been altered is received. One of first duration, first datein information, and first dateout information in one or more first location elements is adjusted based on the modification information. Flight information relating to an airline flight to be taken during the trip is received. One of a second duration information and a second datein information in a second location element is adjusted based on the flight information.

In another embodiment, the first itinerary further comprises a start element including a duration field having a NULL value, a datein field having a NULL value, and a dateout field having a dateout value corresponding to a first value stored in a datein field of a subsequent location element, an end element including a duration field having a NULL value, a datein field having a datein value corresponding to a second value stored in a datein field of a previous location element, and a dateout field having a NULL value.

In another embodiment, the transportation comprises one of an airline flight, a train ride, a boat ride, a ferry ride, a car ride, and a bus ride.

In another embodiment, a third itinerary comprising a plurality of local elements associated with local hotels and local events scheduled during the trip is maintained. In one embodiment, the first itinerary, the second itinerary, and the third itinerary are displayed on a display.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a trip manager in accordance with an embodiment;

FIGS. 3A-3U show web pages that may be used to create, modify, and display an itinerary in accordance with various embodiments;

FIGS. 4A-4E show versions of an itinerary in accordance with an embodiment;

FIGS. 4F-4G show versions of a transport itinerary in accordance with an embodiment;

FIGS. 4H-4I show versions of a local itinerary in accordance with an embodiment;

FIG. 5A is a flowchart of a method of adding an element to a trip itinerary in accordance with an embodiment;

FIG. 5B is a flowchart of a method of removing an element from a trip itinerary in accordance with an embodiment;

FIG. 5C is a flowchart of a method of modifying an element in accordance with an embodiment:

FIG. 5D is a flowchart of a method of incorporating a transport element into an itinerary in accordance with an embodiment;

FIG. 6 shows a schematic illustration of a calculation function in accordance with an embodiment;

FIG. 7 is a flowchart of a method of managing a trip itinerary in accordance with an embodiment;

FIG. 8 is a flowchart of a method of managing a travel itinerary in accordance with another embodiment; and

FIG. 9 is a high-level block diagram of an exemplary computer that may be used to implement certain embodiments.

### DETAILED DESCRIPTION

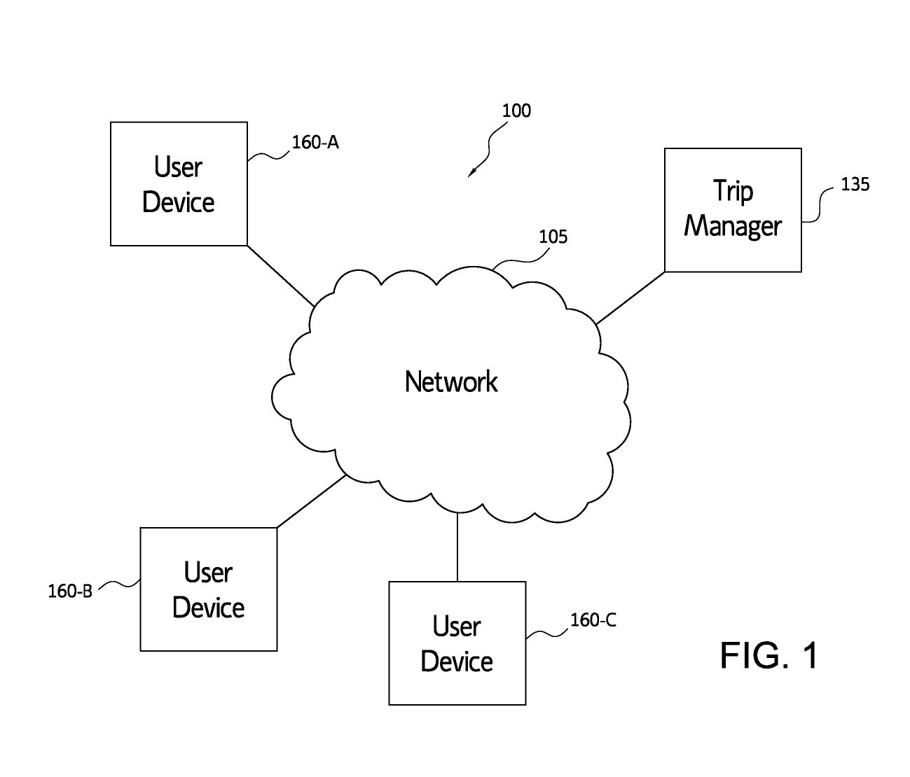

FIG. 1 shows a communication system in accordance with an embodiment. Communication system 100 comprises a network 105, a trip manager 135, and a plurality of user devices 160-A, 160-B, 160-C, etc. For convenience, the term “user device 160” is sometimes used herein to refer to any one of user devices 160-A, 160-B, 160-C, etc. Accordingly, any discussion herein referring to “user device 160” is equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

User device 160 may be any device that enables a user to communicate via network 105. User device 160 may be connected to network 105 through a direct (wired) link, or wirelessly. User device 160 may have a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

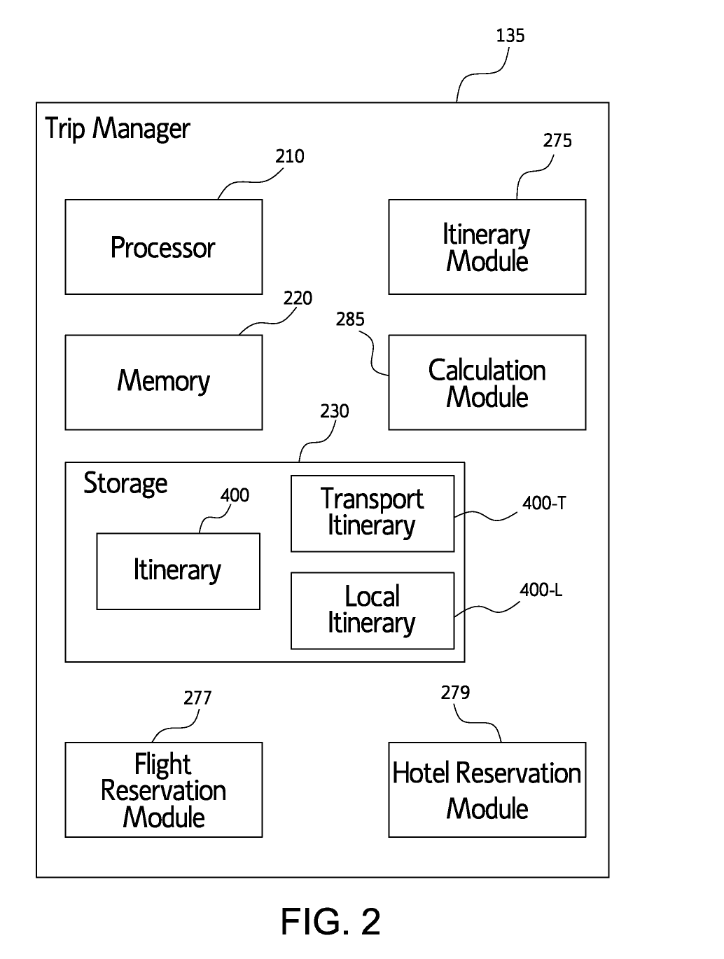

FIG. 2 shows components of trip manager 135 in accordance with an embodiment. Trip manager 135 comprises a processor 210, a memory 220, a storage 230, an itinerary module 275, and a calculation module 285. Processor 210 orchestrates the operations of various components of trip manager 135. Memory 220 and storage 230 may be used by other components of trip manager 135 to store various types of data. Itinerary module 275 creates and manages itineraries for users. Calculation module 285 applies one or more algorithms to an itinerary, for example, to calculate dates within the itinerary. Itinerary module 275 may call calculation module 285 when needed, for example.

Trip manager 135 also includes a flight reservation module 277 and a hotel reservation module 279. Flight reservation module 277 employs known systems and methods to offer flight reservation services to users. Hotel reservation module 279 employs known systems and methods to offer hotel reservation services to users.

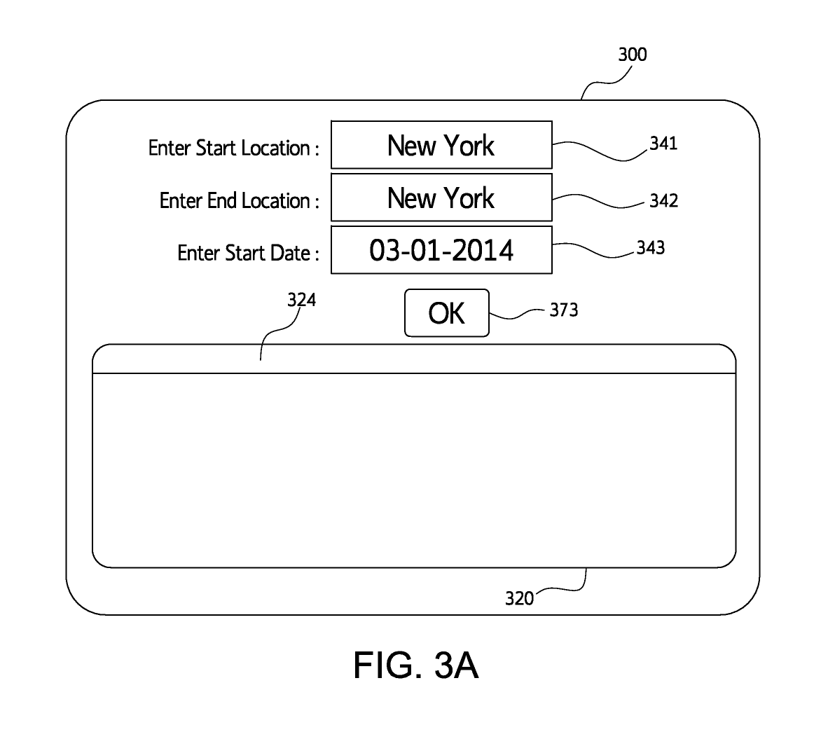

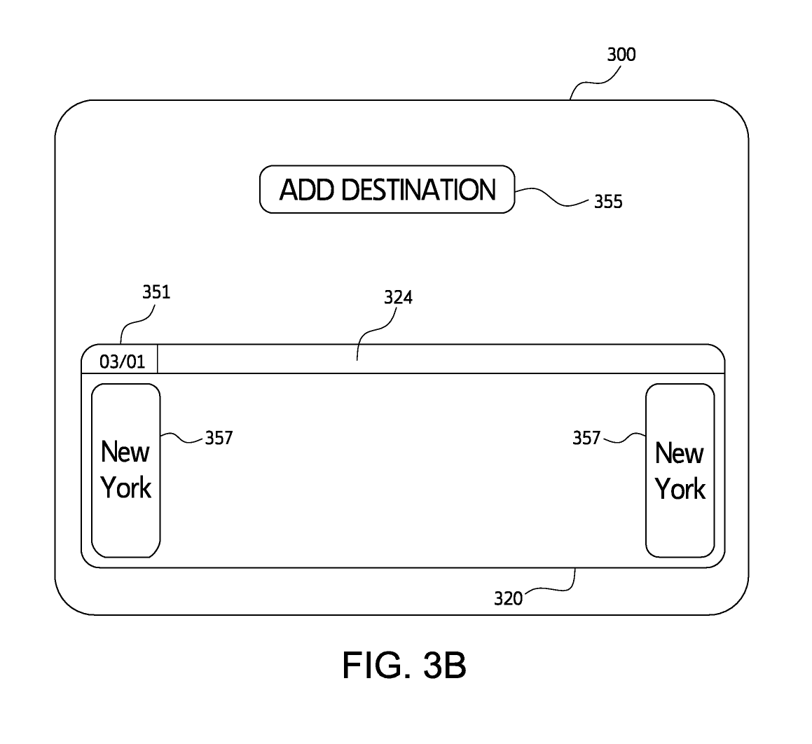

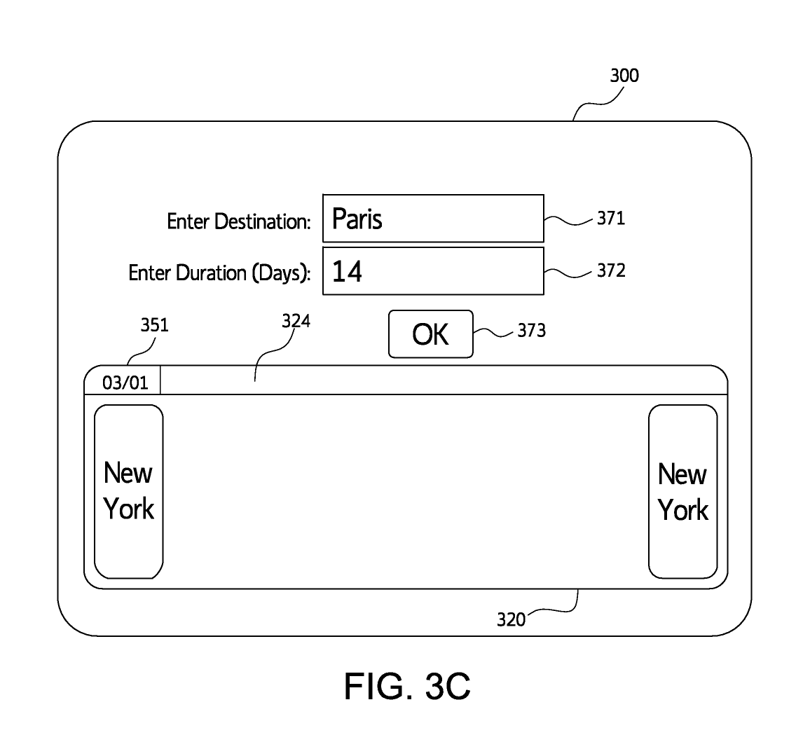

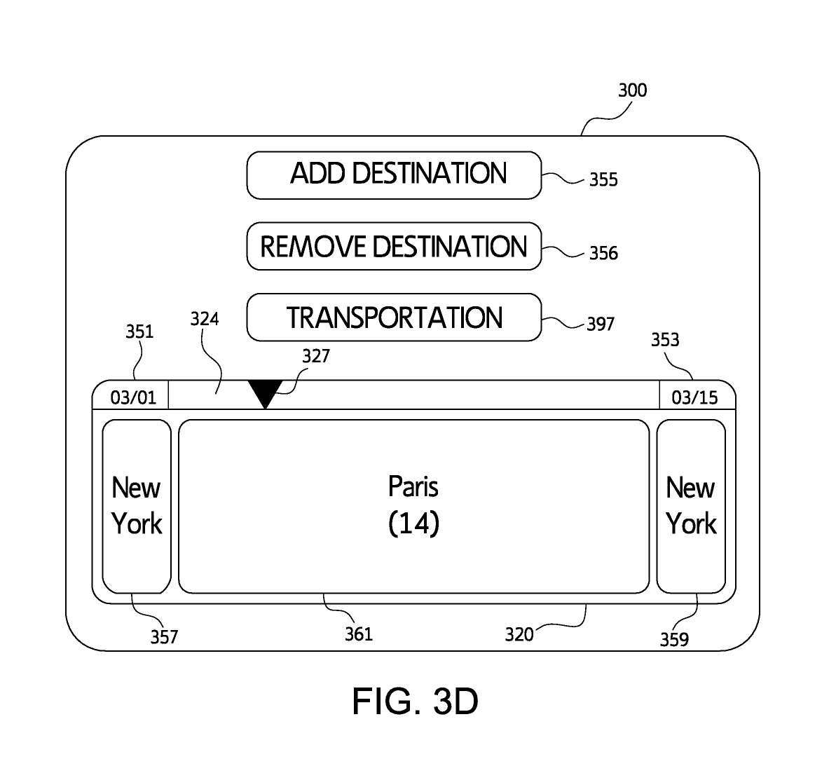

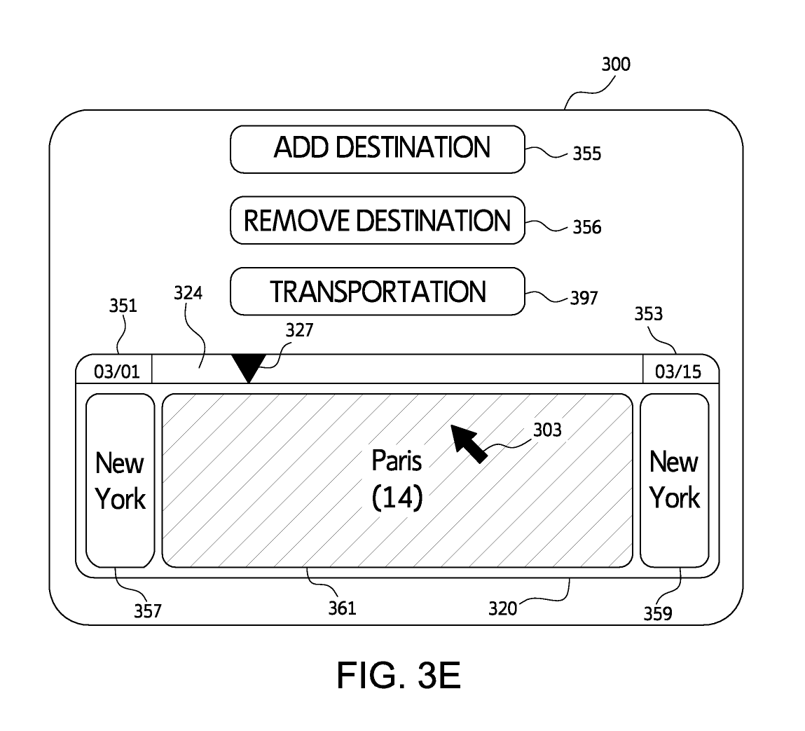

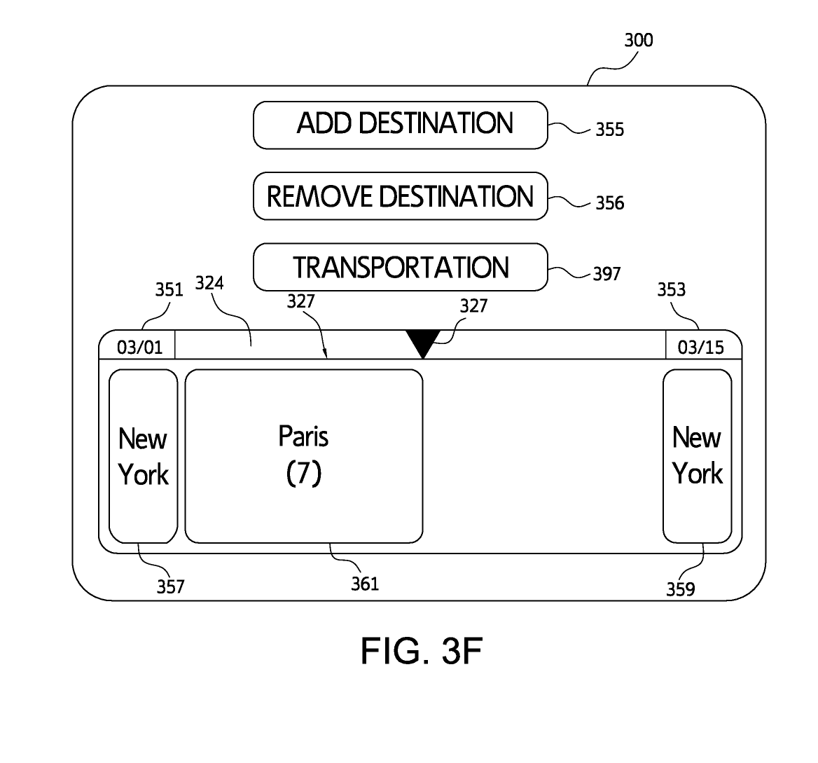

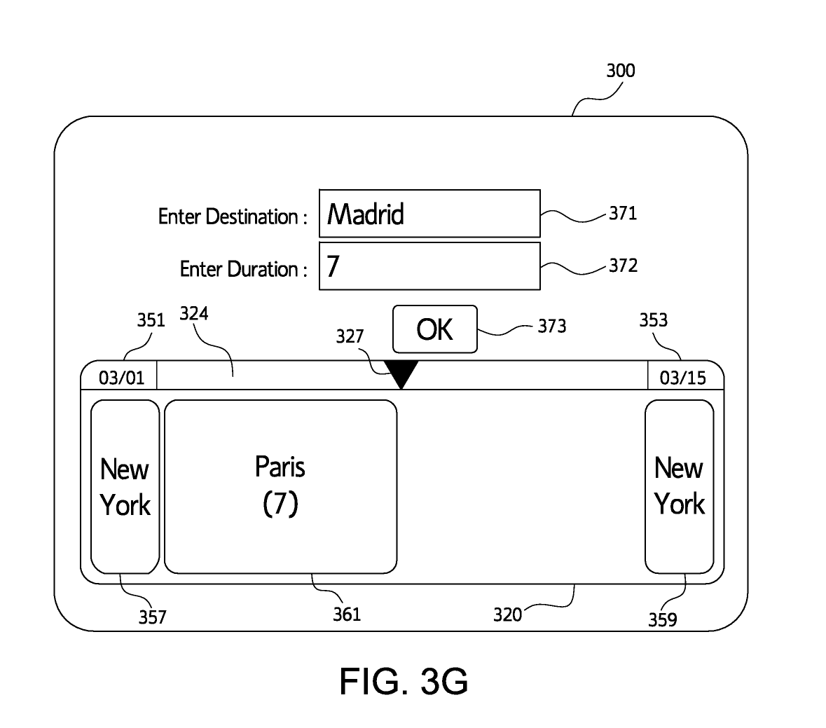

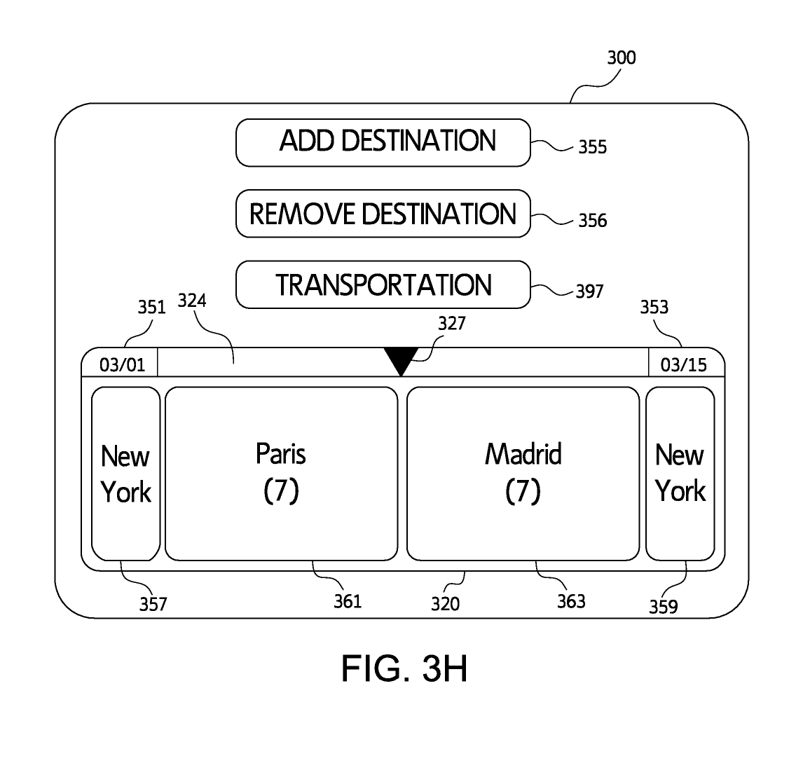

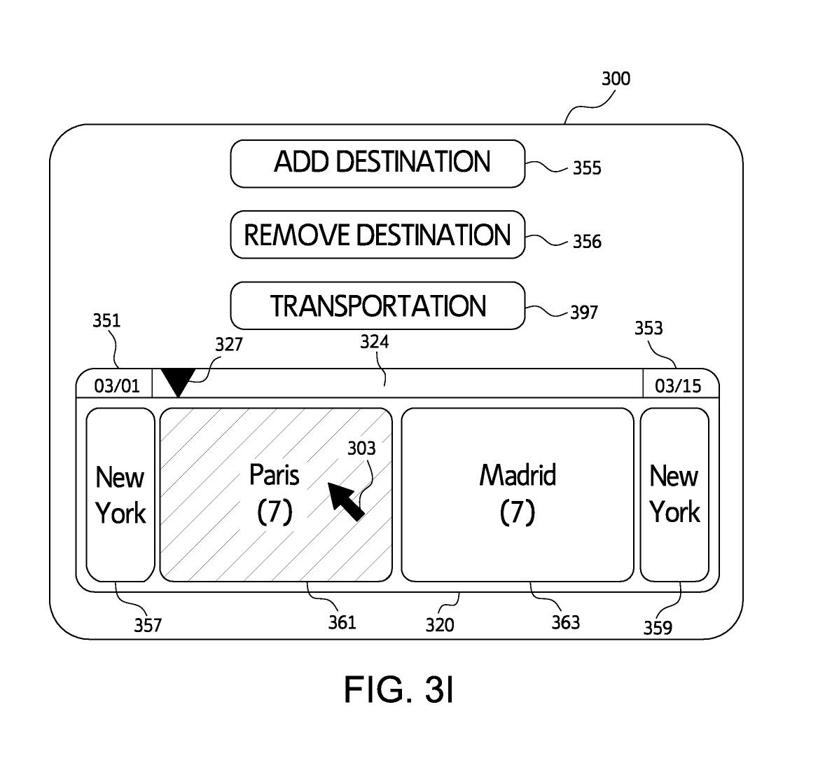

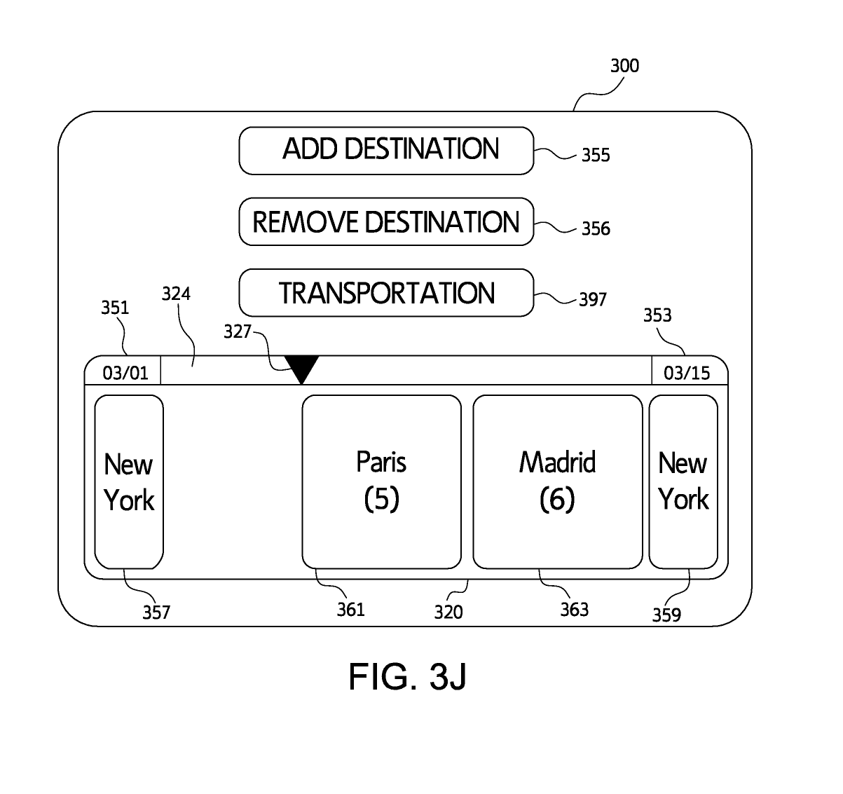

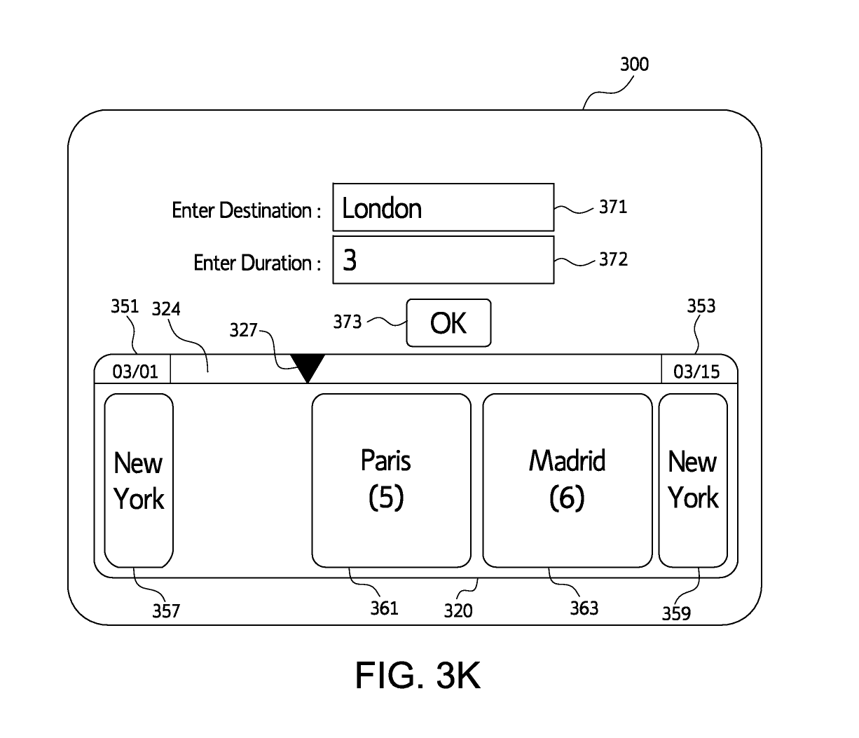

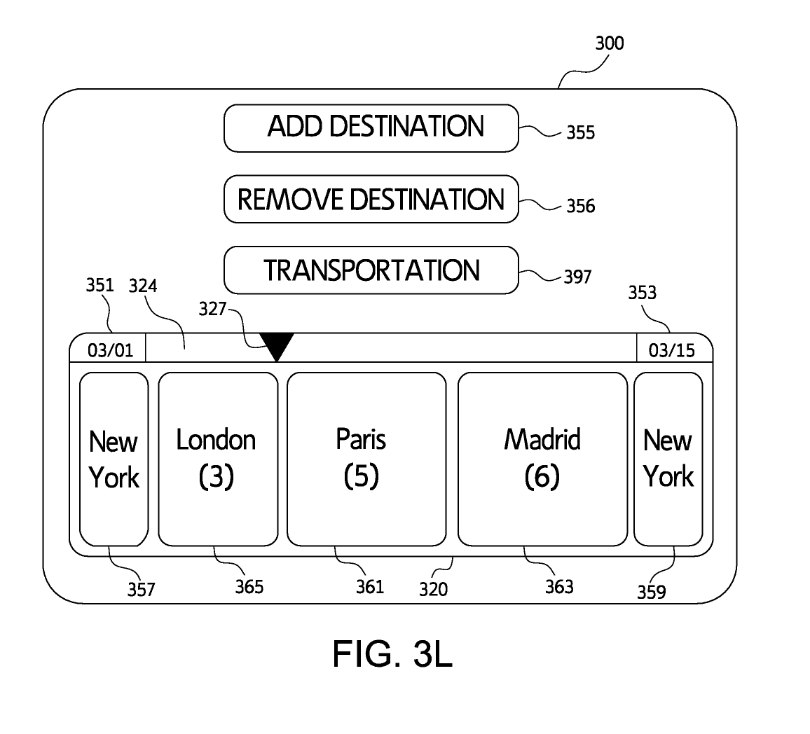

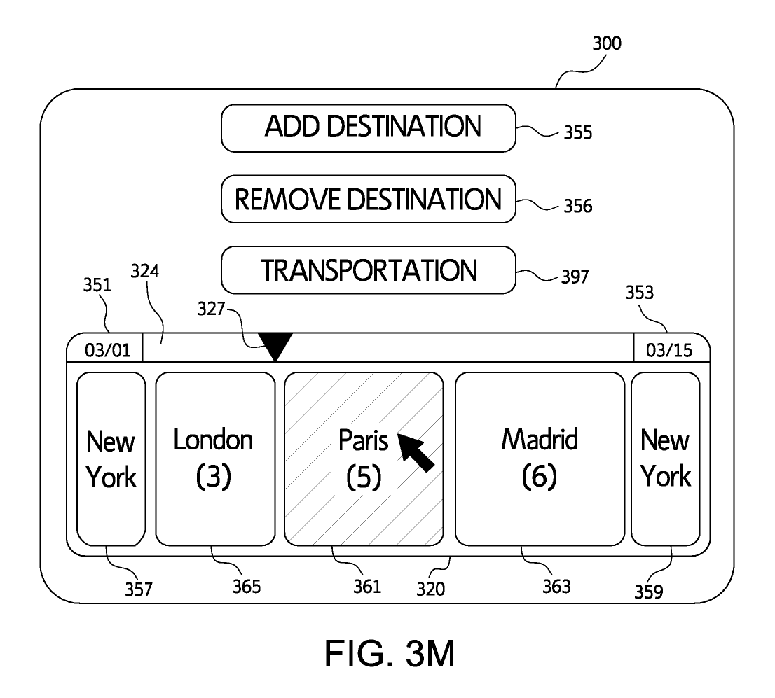

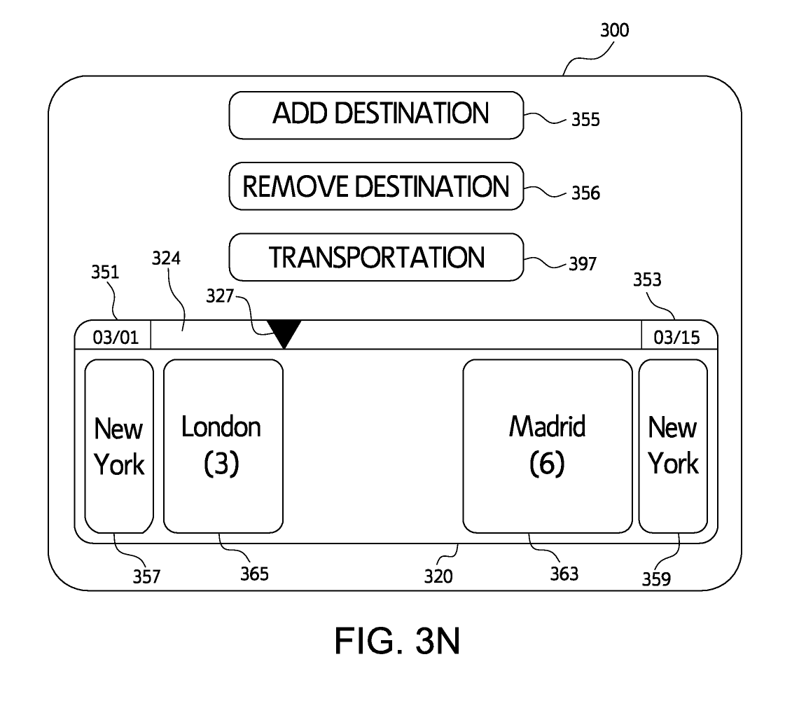

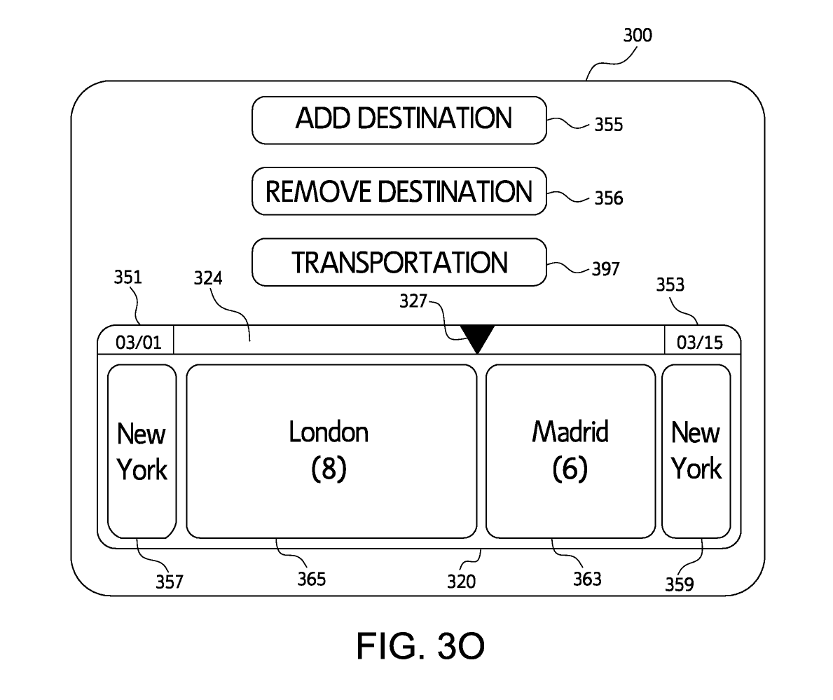

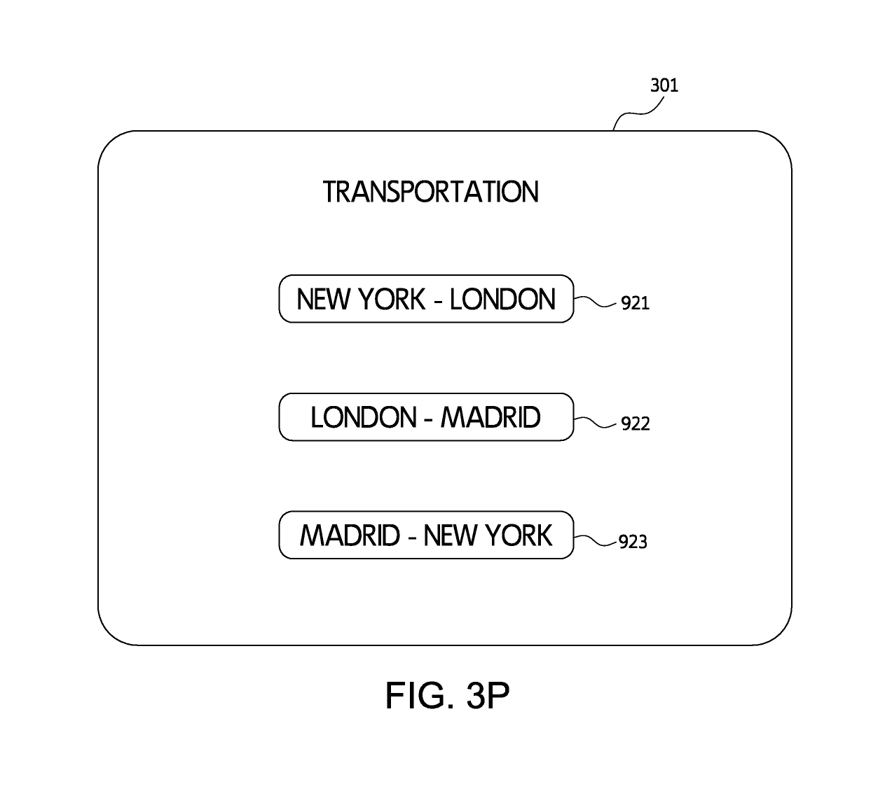

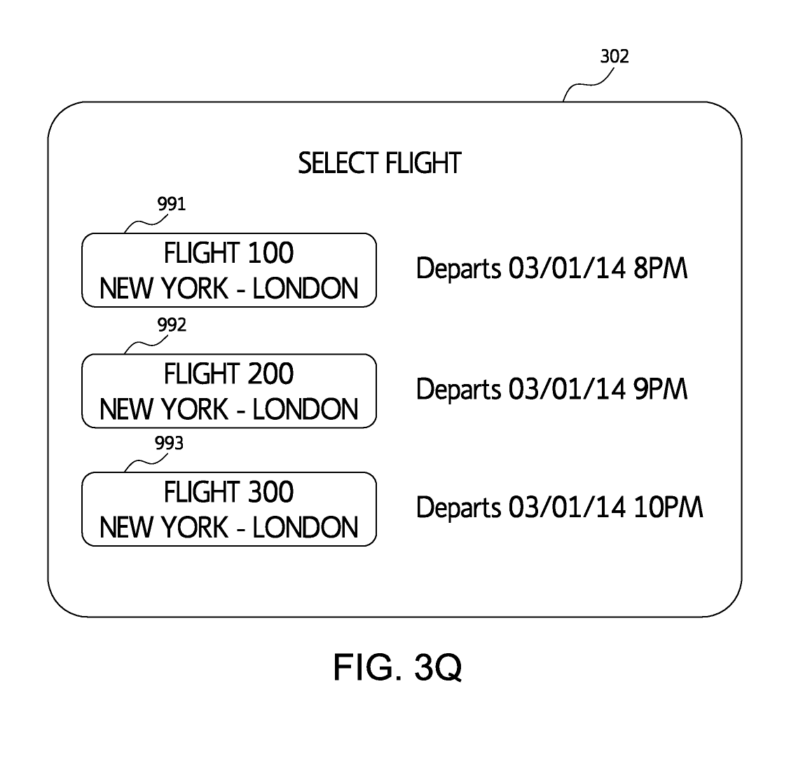

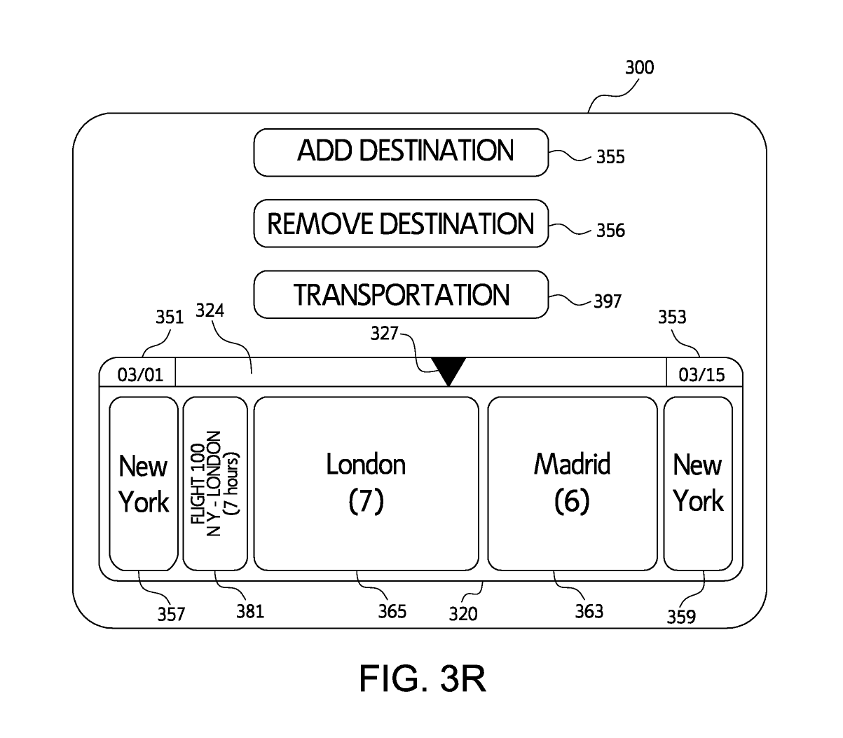

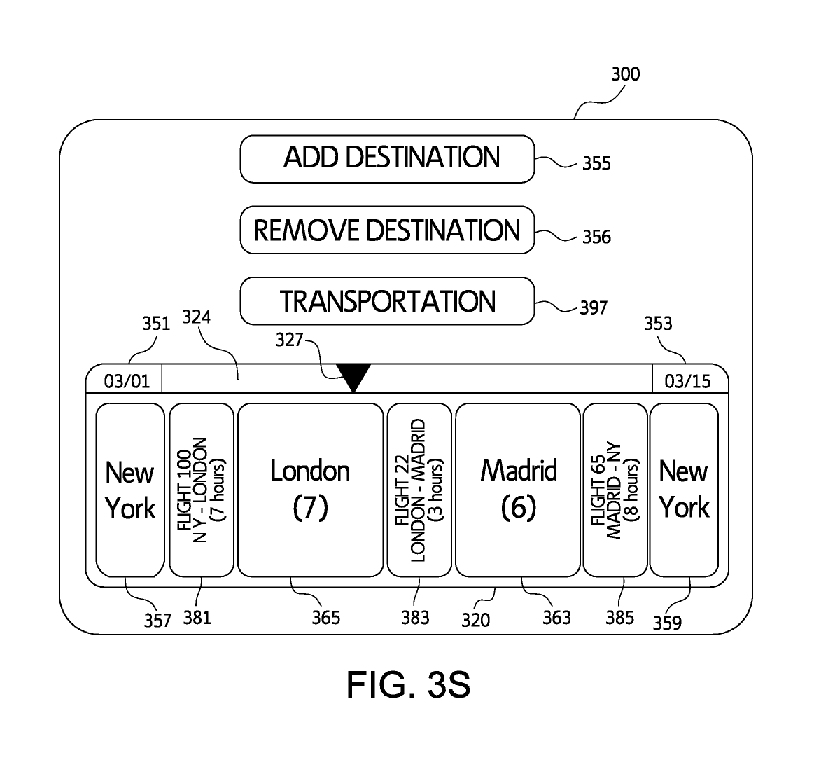

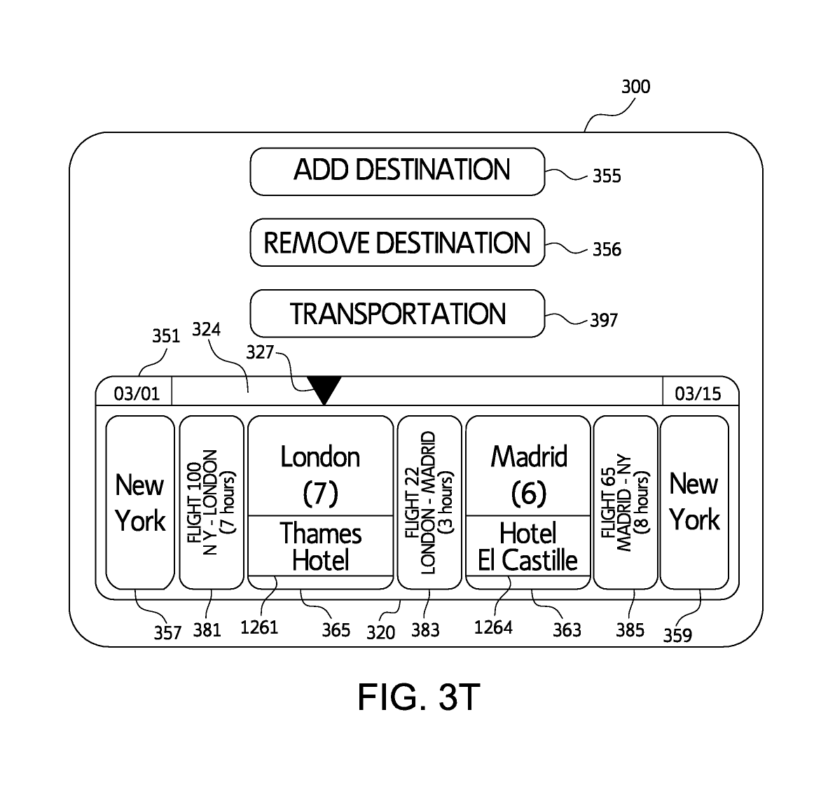

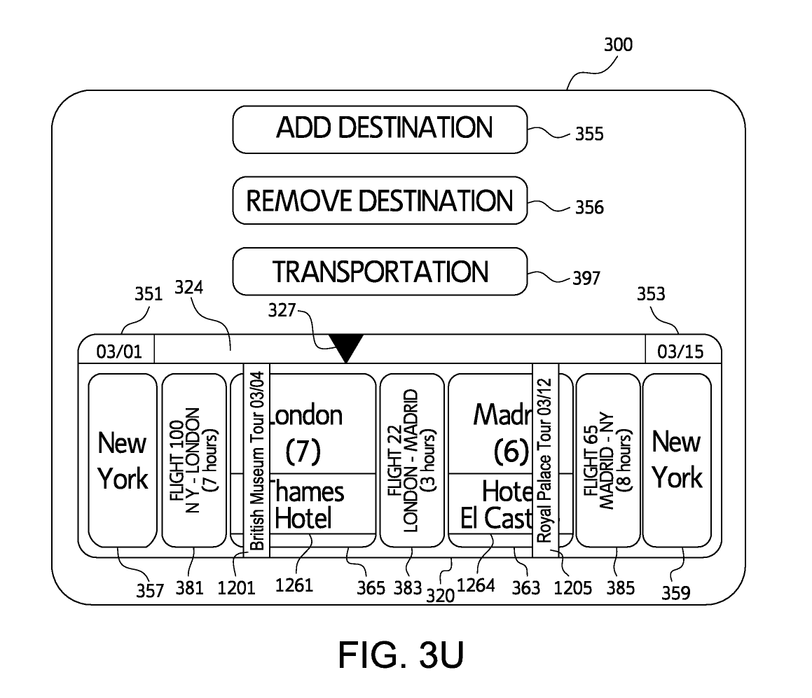

In accordance with an embodiment, one or more users may access trip manager 135 and create, modify, and manage a travel itinerary. In an illustrative example, a user employing user device 160-A accesses trip manager 135 via network 105. Trip manager 135 may provide to user device 160-A access to a web page such as that shown in FIG. 3A. Web page 300 comprises a dashboard 320 (including a timebar 324). In FIG. 3A, because the user has not yet entered any information, dashboard 320 and timebar 324 are empty. Web page 300 also includes a start location in field 341, an end location field 342 and a start date in field 343. When the user wishes to begin building an itinerary, he or she may enter a start location into field 341, and end location into field 342, and a start date into field 343. The system allows for a user to define a one-way trip starting from a first location and ending at a second location (with possible intermediate locations), or a round-trip itinerary starting and ending at the same location (with one or more intermediate locations).

In another embodiment, a geo-location functionality may be used to determine the current location of the user and automatically determine the start′end location of the user based on the user's current location. In such case, for example, it may not be necessary to prompt the user to enter this information; it may be sufficient to display the location and ask the user to confirm the start/end location.

While in the illustrative embodiment, a web page is used, systems and methods described herein may be implemented using other types of interfaces adapted to present information to a user and/or receive information from a user. For example, in another embodiment, a page associated with a mobile software application (App) suitable for a mobile communication device, or a page associated with any software application associated with a tablet device or any other type of device, may be used. In another embodiment, a page generated by a software application residing and operating on a personal computer may be used. Other types of interfaces may be used.

In the illustrative example, the user wishes to schedule a round trip from New York to Paris starting on March 1 of the year 2014, and accordingly specifies “New York” in start location field 341, “New York” in end location field 342, and “03-01-2014” in start date field 343. The user may then submit the information by pressing an OK button 373.

Trip manager 135 receives the information from user device 160-A and begins to generate an itinerary based on the information received from the user. In accordance with an embodiment, an itinerary comprises a plurality of location elements, each including a place field indicating a location, a duration field indicating a number of nights spent at the respective location during the trip, a datein field indicating the date when the traveler is to arrive at the location, and a dateout field indicating a date when the traveler is to depart from the location. For example, in one embodiment each location element may be an object created and maintained within an object-oriented programming architecture. In other embodiments, other programming architectures and structures may be used.

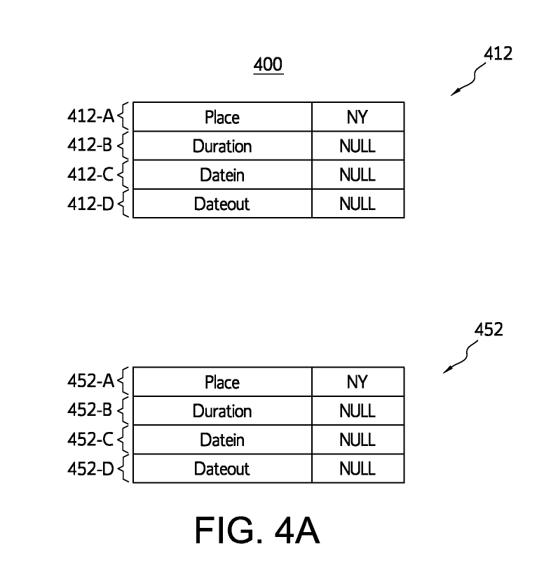

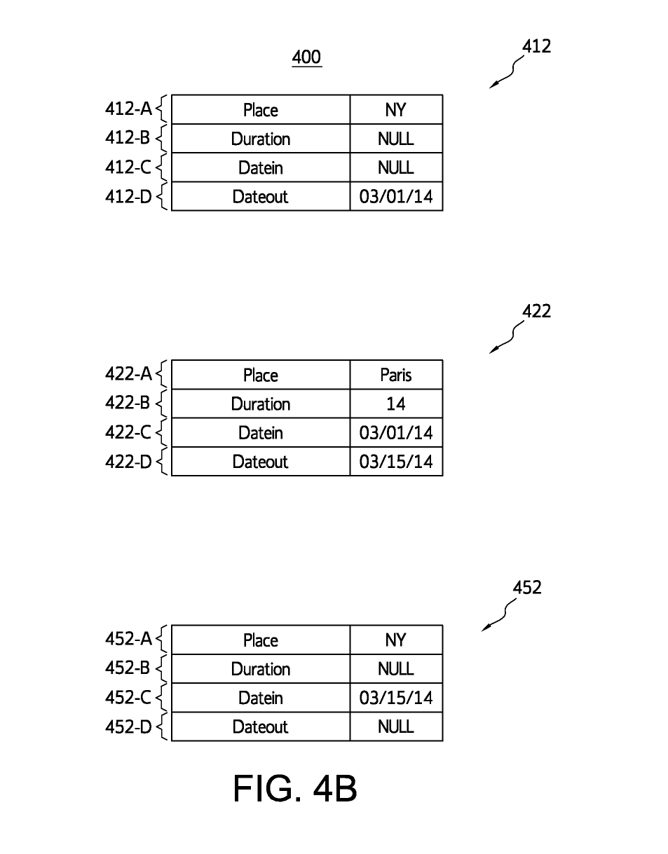

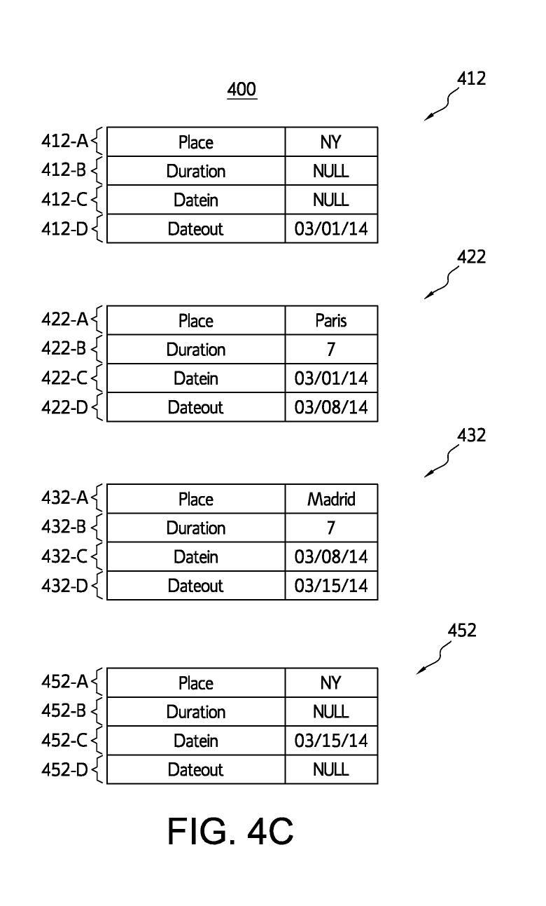

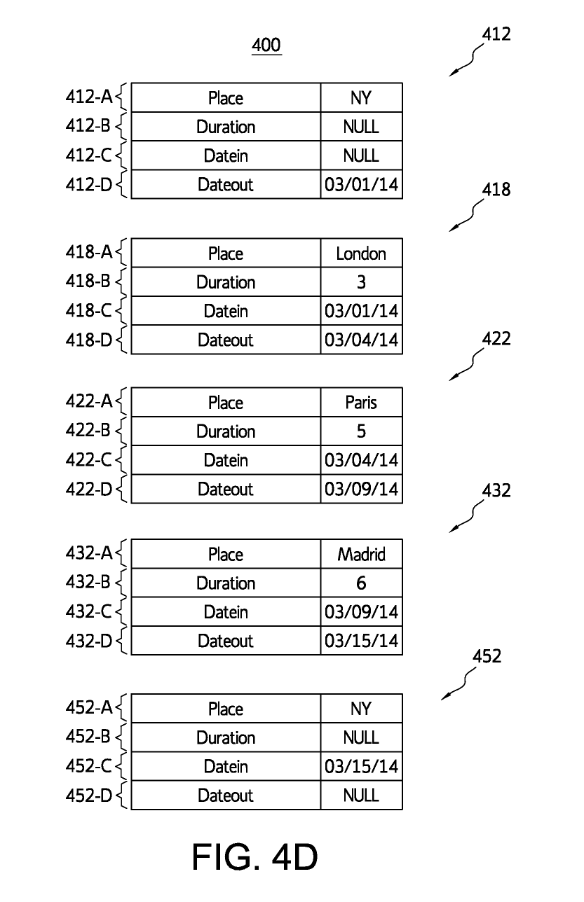

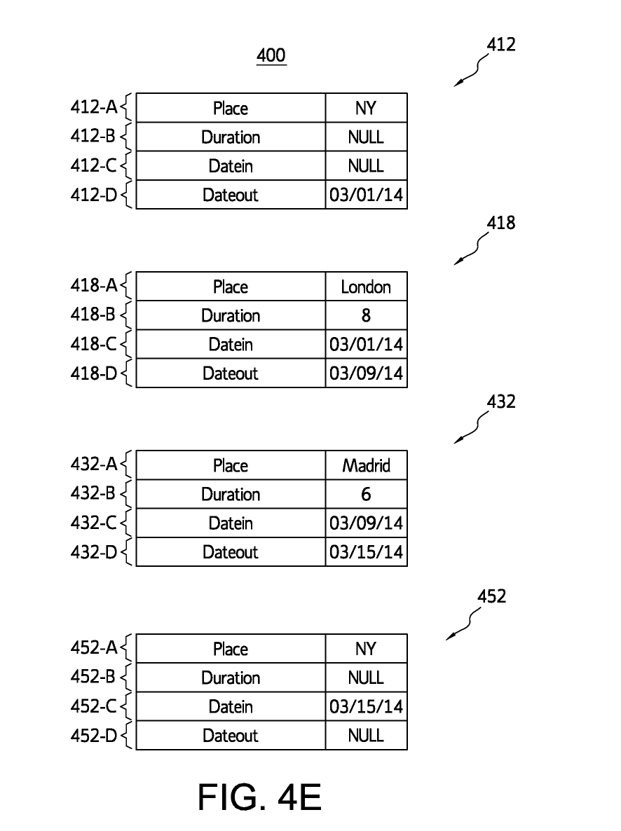

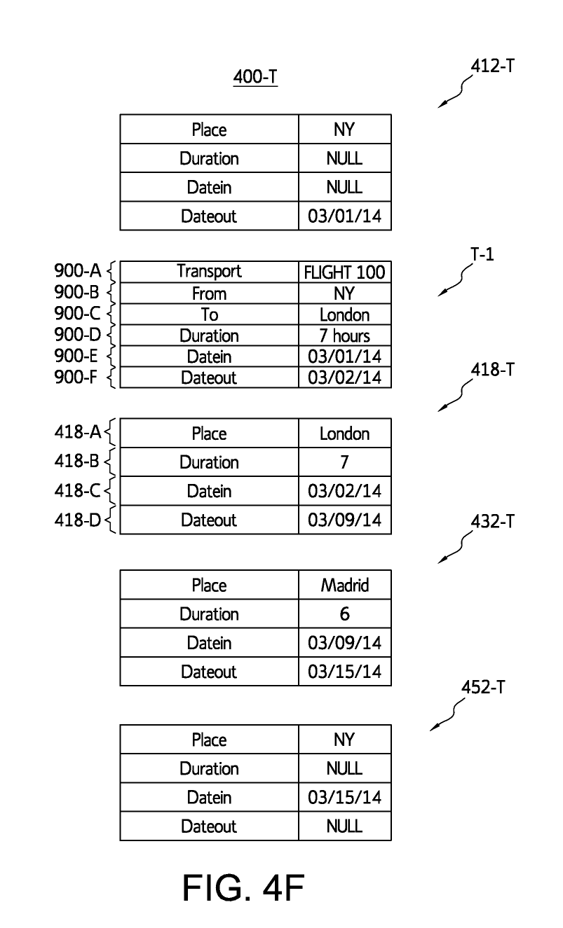

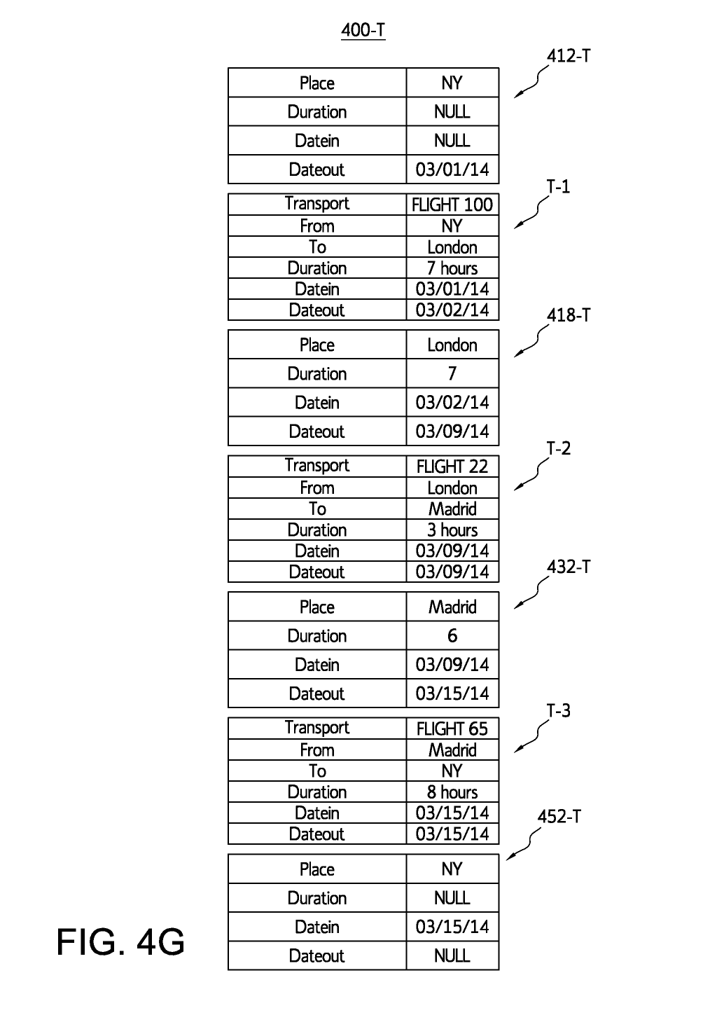

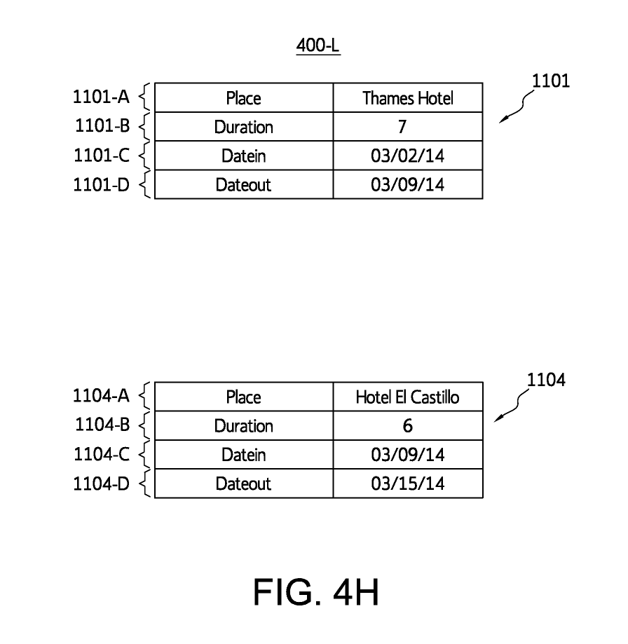

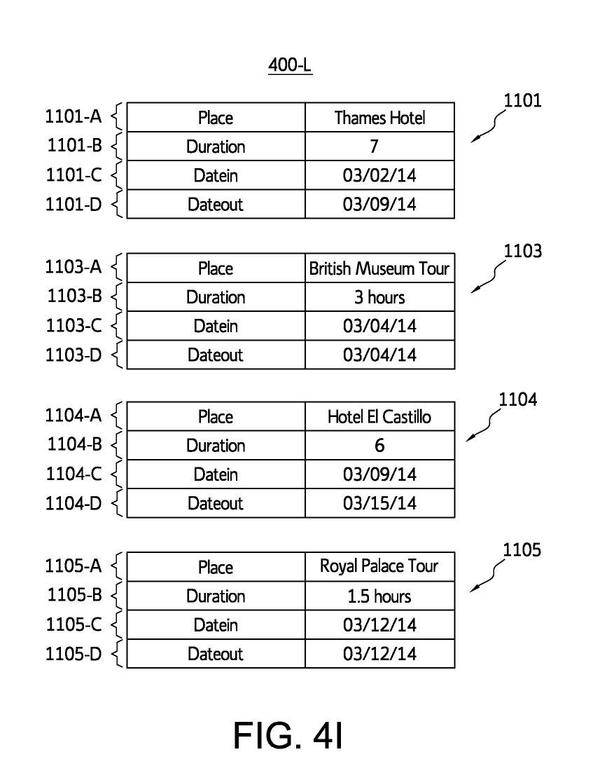

Based on the information received from the user, itinerary module 275 generates an itinerary such as that shown in FIG. 4A. Itinerary 400 includes a start element 412 and an end element 452. Start element 412 includes a place field 412-A, a duration field 412-B, a datein field 412-C, and a dateout field 412-D. Based on the information received from the user, “NY,” (representing New York) is stored in place field 412-A. Duration field 412-B, datein field 412-C, and dateout field 412-D are populated with NULL values. End element 452 includes a place field 452-A, a duration field 452-B, a datein field 452-C, and a dateout field 452-D. Based on the information received from the user, “NY” is stored in place field 452-A. Duration field 452-B, datein field 452-C, and dateout field 452-D are populated with NULL values. Itinerary 400 is stored in storage 230, as shown in FIG. 2.

Itinerary module 275 displays itinerary 400 graphically on dashboard 320. Referring to FIG. 3B, dashboard 320 now includes a first square 357 labeled “New York,” representing the user's starting location, and a second square 359 labeled “New York” representing the user's end location. The user's start date is indicated at point 351 of timebar 324. Trip manager 135 also displays an “ADD DESTINATION” button 355 on web page 300.

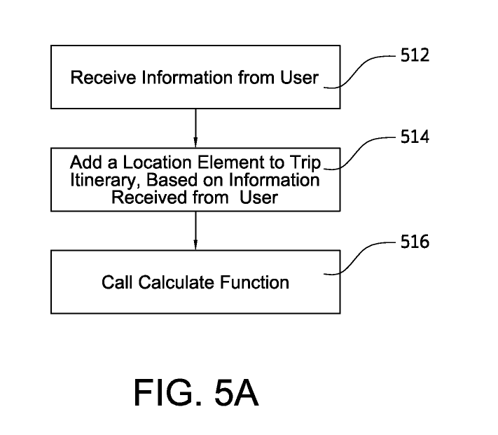

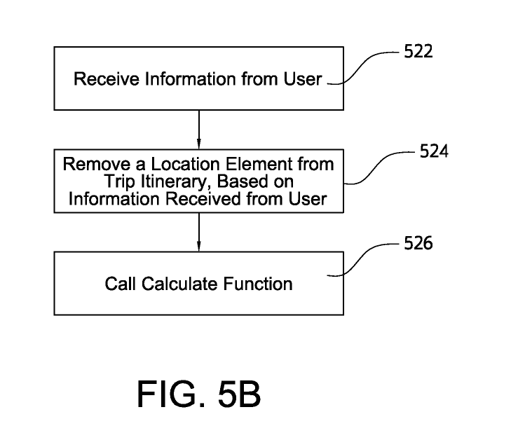

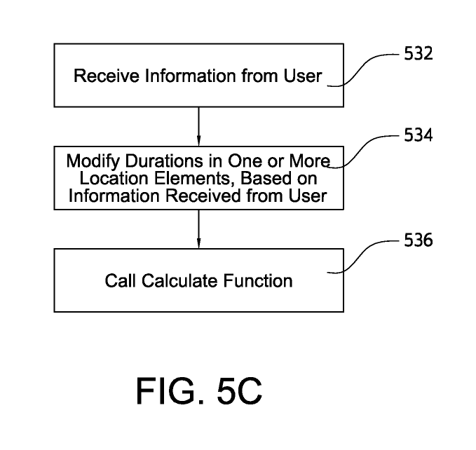

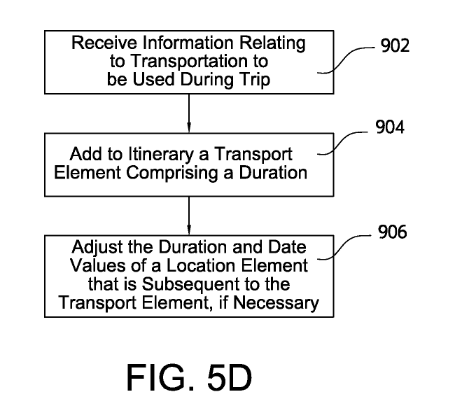

The user may make modifications to an itinerary by adding or removing destinations, adjusting the durations associated with various destinations, etc. In accordance with one embodiment, modifications made to an itinerary are processed in accordance with one or more sets of rules. FIGS. 5A-5C, 6, and 7 illustrate examples of rule sets that may be applied to process modifications to an itinerary in accordance with various embodiments.

FIG. 5A is a flowchart of a method of adding an element to a trip itinerary in accordance with an embodiment. At step 512, information is received from a user. At step 514, a location element is added to the trip itinerary, based on the information received from the user. At step 516, a calculate function is called. The calculate function is discussed below.

FIG. 5B is a flowchart of a method of removing an element from a trip itinerary in accordance with an embodiment. At step 522, information is received from a user. At step 524, a location element is removed from a trip itinerary, based on the information received from the user. At step 526, the calculate function is called.

FIG. 5C shows a method of modifying an element in accordance with an embodiment. At step 532, information is received from a user. At step 534, one or more durations in one or more location elements are modified, based on the information received from the user. At step 536, the calculate function is called.

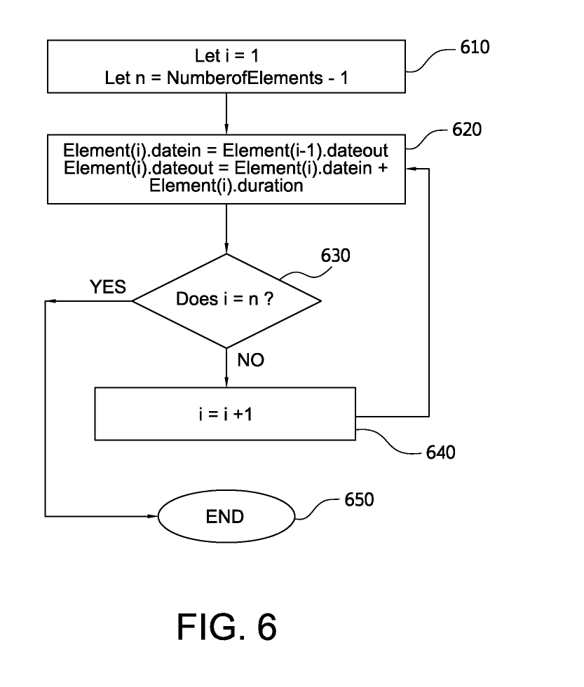

FIG. 6 shows a schematic illustration of a calculate function in accordance with an embodiment. In this routine, the itinerary contains n elements; each element is referred to as element(i), where i is an integer from 0 to n. The start element of the itinerary is element(0). At block 610, the integer i is set to one (1), and the integer n is set equal to the number of elements currently in the itinerary, minus one. At block 620, the datein field of element(i) is set equal to the dateout value of the previous element (element(i−1)), and the dateout field of the current element(i) is set equal to the datein value of the current element (element(i)) plus the duration value of the current element (element(i)). Referring to block 630, if i=n, then the routine proceeds to block 650 and ends. Otherwise, the routine proceeds to block 640. At block 640, the integer i is incremented by one, and the routine returns to block 620.

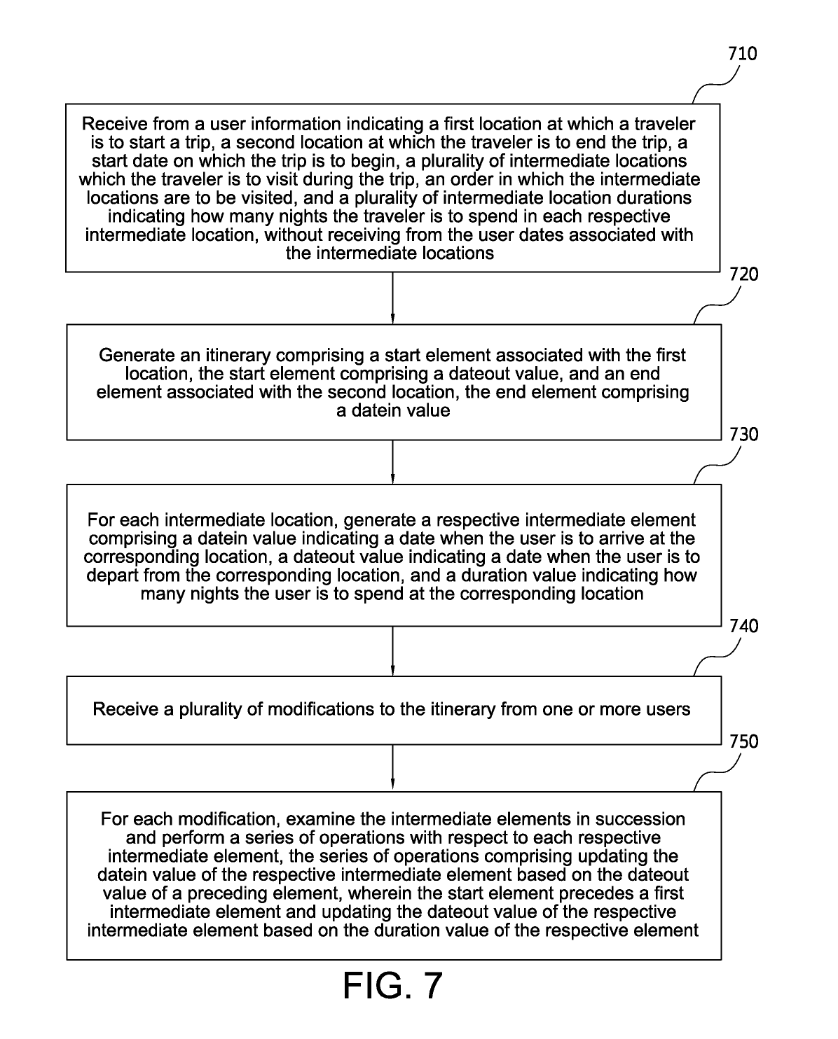

FIG. 7 is a flowchart of a method of managing a trip itinerary in accordance with an embodiment. At step 710, information indicating a first location at which a traveler is to start the trip, a second location at which the traveler is to end the trip, a start date on which the trip is to begin, a plurality of intermediate locations which the traveler is to visit during, the trip, an order in which the intermediate locations are to be visited, and a plurality of intermediate location durations indicating how many nights the traveler is to spend in each respective intermediate location is received from a user, while dates associated with the intermediate locations are not received from the user. At step 720, an itinerary comprising a start element associated with the first location, the start element comprising a dateout value, and an end element associated with the second location, the end element comprising a datein value, is generated. Referring to block 730, for each intermediate location, a respective intermediate element comprising a datein value indicating a date when the user is to arrive at the corresponding location, a dateout value indicating a date when the user is to depart from the corresponding location, and a duration value indicating how many nights the user is to spend at the corresponding location, is generated. At step 740, a plurality of modifications to the itinerary are received from the user. Referring to block 750, for each modification, the intermediate elements are examined in succession and a series of operations are performed with respect to each respective intermediate element. The series of operations include updating the datein value of the respective intermediate element based on the dateout value of a preceding element, wherein the start element precedes a first intermediate element, and updating the dateout value of the respective intermediate element based on the duration value of the respective element.

Returning to the illustrative embodiment, suppose that the user now wishes to add an intermediate destination to itinerary 400. Referring again to FIG. 3B, the user selects “ADD DESTINATION” button 355. In response, trip manager 135 displays an Add Destination field 371 and an Enter Duration field 372 on web page 300, as shown in FIG. 3C. Because the user wishes to spend 14 nights in Paris, the user enters “Paris” in field 371 and “14” in field 372. In accordance with the routine defined in FIG. 5A, a location element is added to the itinerary based on information received from the user, and the calculate function is called.

Specifically, referring to FIG. 4B, itinerary module 275 generates an intermediate element 422 and adds element 422 to itinerary 400. Element 422 includes a place field 422-A specifying PARIS, a duration field 422-B specifying “14,” a datein field 422-C, and a dateout field 422-D. Itinerary module 275 calls calculation module 285 to perform the calculate function and determine values for datein field 422-C and dateout field 422-D.

Calculation module 285 performs the calculate function by applying the algorithm defined in FIG. 6. For purpose of the algorithm, the start element 412 is element(0), the intermediate element 422 specifying Paris is element(1) and the end element 452 is element(2).

Starting at block. 610 of FIG. 6, the integer i is set to 1 and the integer n is set to 2 (the number of elements in the itinerary, 3, minus 1). Referring to block 620, the datein field of element(1) is set to the dateout value of element(0), which is “03/01/14.” Also, the dateout value of element(1) is set equal to the datein value of element(1) plus the duration value of element(1), which is “03/01/14” plus “14” and thus “03/15/14.”

At block 630, because i is not equal to n, the routine proceeds to block 640 and i is incremented by 1. Therefore, i is now equal to 2. The routine returns to block 620.

Again at block 620, the datein value of element(2) is set equal to the dateout value of the previous element, element(1), and therefore is set equal to “03/15/14.” Because the duration value of element(2) is NULL, the dateout value of element(2) is also set to NULL.

Referring to block 630, because i=a, the routine proceeds to block 650 and ends. Location element 422, and end element 452, are updated accordingly, as shown in FIG. 4B.

As used herein, the term “location element” may be used to refer to start elements such as start element 412, end elements such as end element 452, as well as intermediate elements.

The updated itinerary 400 is displayed visually on dashboard 320. Referring to FIG. 3D, dashboard 320 now contains start and end squares 357, 359 and an intermediate square 361 representing 14 nights in Paris. The user's end date “03/15” is shown at point 353 of timebar 324.

Supposing that the user wishes to add another intermediate destination, the user may adjust the duration of the Paris square 361, for example, by causing a cursor 303 to hover over square 361, as shown in FIG. 3E, and double clicking to cause square 361 to appear shaded. Then, by moving arrow 327 (within timebar 324) to a position above the right edge of Paris square 361, and double-clicking to activate an adjust duration function, the user may shift the position of the right edge of Paris square 361 to the left, as shown in FIG. 3F. As the right edge of Paris square 361 moves to the left, the duration of the Paris portion of the itinerary decreases. In the illustrative example, the user shortens the duration of the Paris block 361 to 7 nights.

Other methods may be used to adjust the duration of a particular portion of an itinerary (such as Paris block 361 in the example above). For example, in another embodiment, a user may click on an edge of a square, such as Paris square 361, and drag the edge from its current position to a new position (i.e., to the right or to the left), thereby either reducing or increasing the shape of the square. As a result, the user either decreases or increases the duration of the corresponding portion of the itinerary.

As the user wishes to add another intermediate destination, the user selects ADD DESTINATION button 355 to obtain Destination field 371 and Duration field 372, as shown in FIG. 3G. The user specifies “Madrid” in field 371 and “7” in field 372 indicating that the user wishes to spend 7 nights in Madrid.

In accordance with the rule sets of FIG. 5C and FIG. 5A, itinerary module 275 modifies the duration in location element 422 (specifying Paris), and adds another intermediate element to itinerary 400, based on information received from the user. Referring to FIG. 4C, itinerary module 275 updates the duration value of element 422 to be equal to “7,” as indicated by the user. Itinerary module 275 also generates another intermediate element 432 within itinerary 400. Intermediate element 432 includes a place field 432-A specifying MADRID, a duration field 432-B specifying “7,” a datein field 432-C, and a dateout field 432-D. Calculation module 285 is now called to determine values for datein field 432-C and dateout field 432-D.

Calculation module 285 applies the algorithm defined in FIG. 6. For purposes of the algorithm, the start element 412 is element(0), intermediate element 422 specifying Paris is element(1), intermediate element 432 specifying Madrid is element(2), and end element 452 is element(3).

Starting at block 610 of FIG. 6, the integer i is set to 1 and the integer n is set to 3 (the number of elements in the itinerary, 4, minus 1). Referring to block 620, the datein field of element(1) is set to the dateout value of element(0), which is “03/01/14.” Also, the dateout value of element(1) is set equal to the datein value of element(1) plus the duration value of element(1), which is “03/01/14” plus 7 and thus “03/08/14.” Intermediate element 422 is updated accordingly.

At block 630, because i is not equal to n, the routine proceeds to block 640 and i is incremented by 1. Therefore, i is now equal to 2. The routine returns to block 620.

Again at block 620, the datein value of element(2) is set equal to the dateout value of the previous element, element(1), and therefore is set equal to “03/08/14.” The dateout value of element(2) is set equal to the datein value of element(2) plus the duration value of element(2), and thus is set equal to “03/08/14” plus 7, which is “03/15/14.” Referring now to block 630, because i does not equal n, the routine proceeds to block 640, where i is incremented to 3, and then returns to block 620.

Again at block 620, the datein value of element(3) is set equal to the dateout value of the previous element, element(2), and therefore is set equal to “03/15/14.” Because the duration value of element(3) is NULL, the dateout value of element(3 is also set to NULL. Elements 432 and 452 are updated, as shown in FIG. 4C.

Proceeding now to block 630, because i=n, the routine proceeds to block 650 and ends. The updated itinerary 400 is stored in storage 230.

The updated itinerary 400 is displayed visually on dashboard 320. Referring to FIG. 3H, dashboard 320 now contains start and end squares 357, 359 intermediate square 361 representing 7 nights in Paris, and an intermediate square 363 representing 7 nights in Madrid.

Now the user wishes to add another intermediate destination. The user causes cursor 303 to hover over Paris square 361 and double-clicks, causing Paris square 361 to appear shaded, as shown in FIG. 3I. The user now uses arrow 327 and the duration function to adjust the duration of the Paris square 361 from 7 nights to 5 nights, as shown in FIG. 3J; the user similarly adjusts the duration of the Madrid square 363 to 6 nights. The user then selects ADD DESTINATION button 355 to obtain Destination field 371 and Duration field 372, as shown in FIG. 3K. The user specifies “London” in field 371 and “3” in field 372 indicating that the user wishes to spend 3 nights in London.

In accordance with the rule sets of FIG. 5C and FIG. 5A, itinerary module 275 updates itinerary 400 by modifying the duration of intermediate element 422 (specifying Paris) and the duration of element 442 (specifying Madrid), and by adding another intermediate element to itinerary 400, based on information received from the user. Referring to FIG. 4D, itinerary module 275 updates the duration value of intermediate element 422 to be equal to “5,” and the duration value of element 432 to be equal to “6,” as indicated by the user. Itinerary module 275 also generates another intermediate element 418 within itinerary 400. Element 418 includes a place field 418-A specifying LONDON, a duration field 418 specifying “3,” a datein field 418-C, and a dateout field 418-D. Calculation module 285 is now activated to determine values for datein field 418-C and dateout field 418-D and to update other dates in itinerary 400, as necessary.

Calculation module 285 applies the algorithm defined in FIG. 6. Now for purposes of the algorithm, the start element 412 is element(0), intermediate element 418 specifying London is element(1), intermediate element 422 specifying Paris is element(2), intermediate element 432 specifying Madrid is element(3), and end element 452 is element(4).

Starting at block 610 of FIG. 6, the integer i is set to 1 and the integer n is set to 4 (the number of elements in the itinerary, 5, minus 1). Referring to block 620, the datein field of element(1) is set to the dateout value of element(0), which is “03/01/14.” Also, the dateout value of element(1) is set equal to the datein value of element(1) plus the duration value of element(1), which is “03/01/14” plus 3 and thus “03/04/14.” Element 418 is updated accordingly.

At block 630, because i is not equal to n, the routine proceeds to block 640 and i is incremented by 1. Therefore, i is now equal to 2. The routine returns to block 620.

Again at block 620, the datein value of element(2) is set equal to the dateout value of the previous element, element(1), and therefore is set equal to “03/04/14.” The dateout value of element(2) is set equal to the datein value of element(2) plus the duration value of element(2), and thus is set equal to “03/04/14” plus 5, which is “03/09/14.” Element 422 is updated accordingly. Referring now to block 630, because i does not equal n, the routine proceeds to block 640, where i is incremented to 3, and then returns to block 620.

Again at block 620, the datein value of element(3) is set equal to the dateout value of the previous element, element(2), and therefore is set equal to “03/09/14.” Because the duration value of element(3) is 6, the dateout value of element(3) is also set to “03/15/14.” Referring now to block 630, because i does not equal n, the routine proceeds to block 640, where i is incremented to 4, and then returns to block 620.

Again at block 620, the datein value of element(4) is set equal to the dateout value of the previous element, element(3), and therefore is set equal to “03/15/14.” Because the duration value of element(4) is NULL, the dateout value of element(4) is also set to NULL.

Proceeding now to block 630, because i n, the routine proceeds to block 650 and ends. The updated itinerary 400 is stored.

The updated itinerary 400 is displayed visually on dashboard 320. Referring to FIG. 3L, dashboard 320 now contains start and end squares 357, 359, intermediate square 365 representing 3 nights in London, intermediate square 361 representing 5 nights in Paris, and intermediate square 363 representing 6 nights in Madrid.

Suppose that the user changes his or her mind and now wishes to remove a destination from the itinerary. Specifically, the user now does not want to visit Paris during the trip. Accordingly, the user causes cursor 303 to hover over Paris square 361 and double-clicks, causing Paris square 361 to appear shaded, as shown in FIG. 3M. The user now selects REMOVE DESTINATION button 356. Itinerary module 275 detects the user's selection and, in accordance with the routine defined in FIG. 5B, removes location element 422 from itinerary 400. As shown in FIG. 4E, itinerary 400 now includes start element 412, location element 418 (London), location element 432 (Madrid), and end element 452. Referring to FIG. 3N, itinerary 400 (with Paris square 361 removed) is displayed visually on web page 300. Suppose that the user further adjusts the duration of the London portion of the trip to 8 nights, as shown in FIG. 3O.

In accordance with the routine of FIG. 5B, itinerary module 275 adjusts the duration of element 418 (London) to 8 nights, based on the information provided by the user. Itinerary module 275 now calls calculation module 285 to update the information in the elements if itinerary 400. Calculation module 285 applies the algorithm defined in FIG. 6. Now, in the current iteration, the start element 412 is element(0), intermediate element 418 specifying London is element(1), intermediate element 432 specifying Madrid is element(2), and end element 452 is element(3).

Starting at block 610 of FIG. 6, the integer i is set to I and the integer n is set to 3 (the number of elements in the itinerary, 4, minus 1). Referring to block 620, the datein field of element(1) is set to the dateout value of element(0), which is “03/01/14.” Also, the dateout value of element(1) is set equal to the datein value of element(1) plus the duration value of element(1), which is “03/01/14” plus 8 and thus “03/09/14.”

At block 630, because i is not equal to n, the routine proceeds to block 640 and i is incremented by 1. Therefore, i is now equal to 2. The routine returns to block 620.

Again at block 620, the datein value of element(2) is set equal to the dateout value of the previous element, element(1), and therefore is set equal to “03/09/14.” The dateout value of element(2) is set equal to the datein value of element(2) plus the duration value of element(2), and thus is set equal to “03/09/14” plus 6, which is “03/15/14.” Referring now to block 630, because i does not equal n, the routine proceeds to block 640, where i is incremented to 3, and then returns to block 620.

Again at block 620, the datein value of element(3) is set equal to the dateout value of the previous element, element(2), and therefore is set equal to “03/15/14,” Because the duration value of element(3) is NULL, the dateout value of element(3) is also set to NULL.

Proceeding now to block 630, because i=n, the routine proceeds to block 650 and ends. Elements 412, 418, 432, and 452 are updated, and the updated itinerary 400 is stored.

In another embodiment, itinerary module 275 generates and maintains a second itinerary layer in which information concerning transportation is stored. In this embodiment, the itinerary elements generated based on duration values received from the user, such as those stored in itinerary 400, are referred to as the first itinerary layer. For example, a second itinerary layer may comprise a plurality of location elements corresponding to the elements in the first itinerary layer and may additionally include one or more transport elements representing transportation components, or transportation events, such as flights, train rides, bus rides, etc. in addition, the duration values, the datein values, and dateout values of the location elements in the second itinerary layer may be adjusted based on the time associated with the transport elements. The first itinerary layer is not adjusted based on information in the second itinerary layer.

FIG. 5D is a flowchart of a method of incorporating a transport element into an itinerary in accordance with an embodiment. At step 902, information relating to transportation to be used during a trip is received from a user. At step 904, a transport element comprising a duration is added to the itinerary. At step 906, the duration and date values of a location element that is subsequent to the transport element within the itinerary are adjusted, if necessary.

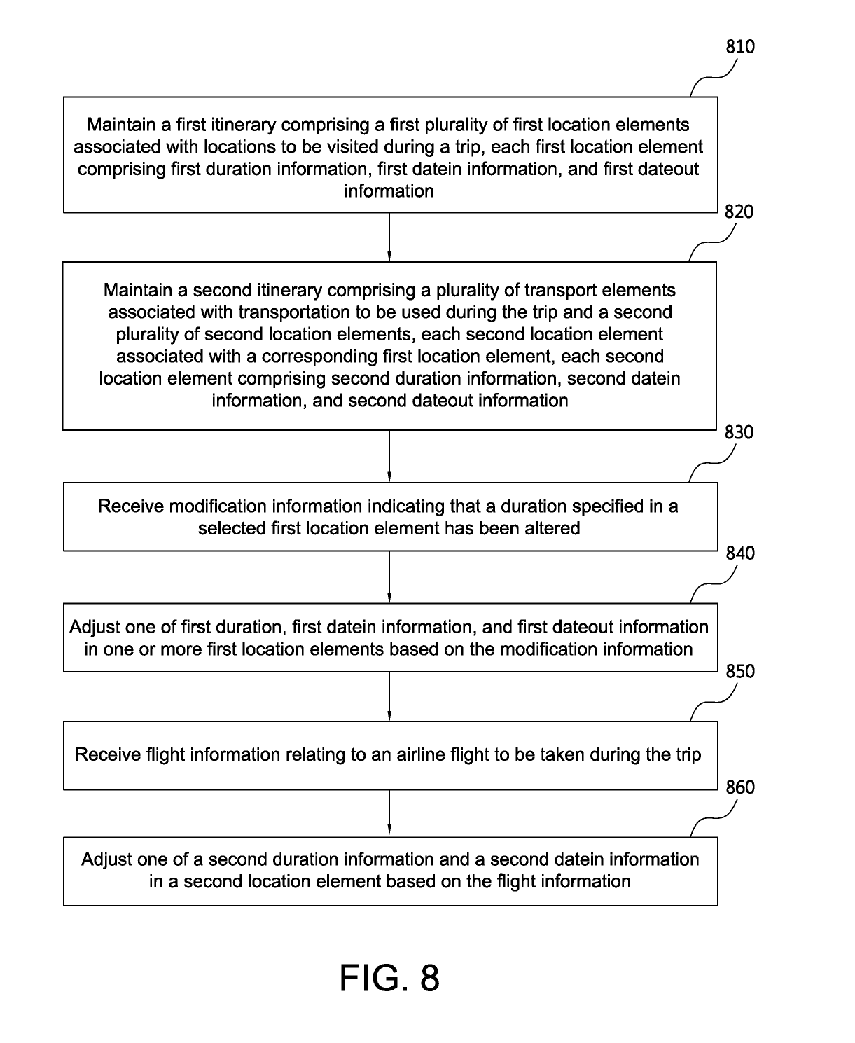

FIG. 8 is a flowchart of a method of managing a travel itinerary in accordance with another embodiment. At step 810, a first itinerary comprising a first plurality of first location elements associated with locations to be visited during a trip, each first location element comprising first duration information, first datein information, and first dateout information, is maintained. At step 820, a second itinerary comprising a plurality of transport elements associated with transportation to be used during the trip and a second plurality of second location elements, each second location element associated with a corresponding first location element, each second location element comprising second duration information, second datein information, and second dateout information, is maintained. At step 830, modification information indicating that a duration specified in a selected first location element has been altered is received. At step 840, one of first duration, first datein information, and first dateout information in one or more first location elements is adjusted based on the modification information. At step 850, flight information relating to an airline flight to be taken during the trip is received. At step 860, one of a second duration information and a second datein information in a second location element is adjusted based on the flight information.

For example, returning to the illustrative embodiment discussed above, suppose that the user is satisfied with the itinerary (as shown in FIG. 3O) and wishes to begin purchasing airplane tickets. The user accordingly selects TRANSPORTATION button 397. Itinerary module 275 detects the user's selection and requests from the user further input specifying for which portion of the trip the transportation is desired. For example, itinerary module 275 may display a selection page such as that shown in FIG. 3P. Selection page 301 includes a NEW YORK-LONDON button 921, a LONDON MADRID button 922, and a MADRID-NEW YORK button 923. The user selects NEW YORK LONDON button 921, indicating that the user wishes to reserve/purchase tickets for a flight for the New York-to-London portion of the trip. Itinerary module 275 now provides to the user a selection of flights from New York to London that are available on the start date (03/01/14). In the illustrative embodiment, itinerary module activates flight reservation module 277. Flight reservation module 277 may utilize any one or more known methods to obtain information concerning available flights, and to offer flight reservation services to users. In the illustrative embodiment, itinerary module 275 provides a web page 302, as shown in FIG. 3Q, showing a first flight 991 (Flight 100), a second flight 992 (Flight 200), and a third flight 993 (Flight 300), all of which depart at various times on 03/01/14.

The user selects the first flight 991 (Flight 100). Itinerary module 275 may execute one or more actions which are not discussed herein, in order to reserve and/or purchase a ticket for Flight 100.

In accordance with the rule set defined in FIG. 5D, itinerary nodule 275 now generates a transport itinerary 400-T, as shown in FIG. 4F. Transport itinerary 400-T is distinct from itinerary 400, and is associated with the second, transport layer. Transport itinerary 400-T includes location elements 412-T, 418-T, 432-T, and 452-T, which are similar to the corresponding location elements within itinerary 400. Transport itinerary 400-T also includes a transport element T-1 associated with Flight 100 reserved by the user. Transport element T-1 comprises a transport field 900-A specifying the particular transport reserved, in this instance “Flight 100.” Transport element T-1 also includes “From” and “To” fields 900-B and 900-C, in this instances specifying “NY” and “London,” respectively. Transport element T-1 also comprises a duration field 900-D, a Datein field 900-E, and a Dateout field 900-F, specifying, in this instance, “7 hours,” “03/01/14,” and “03/02/14,” respectively.

Itinerary module 275 determines whether and how transport element affects other elements within transport itinerary 400-T. Itinerary module 275 determines that transport element T-1 defines a flight which will arrive in London on Mar. 2, 2014 and therefore conflicts with the “03/01/14” datein value of element 418 (as shown in FIG. 4E) Within the second, transport layer, itinerary module 275 therefore resets the datein value of location element 418-T to “03/02/14,” and the duration value of element 418-T from “8” to “7,” as shown in FIG. 4F. Transport itinerary 400-T is stored in storage 230, as shown in FIG. 2. Itinerary 400 is not adjusted.

Referring to FIG. 3R, transport itinerary 400-T is displayed visually on web page 300. Dashboard 320 now displays start and end squares 357 and 359, a transport square 381 associated with Flight 100, and location squares 365 (London) and 363 (Madrid).

In the illustrative embodiment, the user uses similar systems and methods to reserve other flights required for the London-Madrid portion and the Madrid-New York portion of the itinerary. Referring to FIG. 4G, transport itinerary 400-T is updated to include transport elements T-2 (associated with a Flight 22 from London to Madrid) and transport element T-3 (associated with a flight from Madrid to New York). The updated itinerary, including these additional flights, is displayed visually on dashboard 320, as shown in FIG. 3S. Dashboard 320 now displays start and end squares 357 and 359, a transport square 381 associated with Flight 100 from New York to London, location square 365 (London), transport square 383 associated with Flight 22 from London to Madrid, location square 363 (Madrid), and transport square 385 associated with flight 65 from Madrid to New York.

In accordance with another embodiment, a third, local itinerary layer is maintained to enable a user to schedule hotels, local events, tours, shows, etc., at selected locations which will be visited during a trip.

Suppose, in the illustrative embodiment, that the user now wishes to reserve a hotel room at the first destination, London. Itinerary module 275 provides to the user a selection of hotels in London. For example, in the illustrative embodiment, itinerary module 275 activates hotel reservation module 279, which may use any well-known method for identifying available hotels and offering hotel reservation services.

In the illustrative embodiment, the user selects a hotel called the “Thames Hotel” for the duration of the user's stay in London. The user further selects a hotel called the “Hotel Castillo” for the duration of the user's stay in Madrid. Accordingly, itinerary module 275 generates a local itinerary 400-L, as shown in FIG. 4H. Local itinerary 400-L is distinct from itinerary 400 and transport itinerary 400-T and includes local elements associated with local hotels where the user is scheduled to stay during the trip, events that the user is scheduled to attend during the trip, etc.

In the illustrative embodiment of FIG. 4H, local itinerary 400-L includes a local element 1101 that includes a place field 1101-A specifying the Thames Hotel, a duration field 1101-B specifying “7,” a datein field specifying “03/02/14,” and a dateout field 1101-D specifying “03/09/14.” Local itinerary also includes a local element 1104 that includes a place field 1104-A specifying the Hotel El Castillo, a duration field 1104-B specifying “6,” a datein field specifying “03/09/14,” and a dateout field 1104-D specifying “03/15/14.”

Referring to FIG. 3T, local itinerary 400-L is displayed visually on dashboard 320. Hotel bar 1261 specifying the Thames Hotel is overlaid above location square 365 (London); hotel bar 1264 specifying the Hotel El Castillo is overlaid above location square 363 (Madrid).

Suppose now that the user wishes to visit the British Museum while in London, and the Royal Palace while in Madrid. Itinerary module 275 may allow the user to purchase a ticket for a three-hour tour of the British Museum on Mar. 4, 2014 (while the user is scheduled to be in London). Itinerary module 275 also allows the user to purchase a ticket for a 1.5-hour tour of the Royal Palace in Madrid on Mar. 12, 2014 (while the user is scheduled to be in Madrid). Any well-known method may be used to allow a user to reserve and purchase tickets for such events.

Based on information concerning the tours selected by the user, itinerary module 275 now updates local itinerary 400-L, as shown in FIG. 4I. Itinerary module 275 generates within local itinerary 400-L a local element 1103, which includes a place field 1103-A specifying “British Museum Tour,” a duration field 1103-B specifying “3 hours,” a datein field 1103-C specifying “03/04/14,” and a dateout field 1103-D specifying “03/04/14.” Local itinerary 400-L also generates a local element 1105, which includes a place field 1105-A specifying “Royal Palace Tour,” a duration field 1105-B specifying “1.5 hours,” a datein field 1105-C specifying “03/12/14,” and a dateout field 1105-D specifying “03/12/14.”

Referring to FIG. 3U, updated local itinerary 400-L is displayed visually on dashboard 320. Local event bar 1201 associated with the British Museum Tour is overlaid above location square 365 (London) and hotel bar 1261. Local event bar 1205 associated with the Royal Palace Tour is overlaid above location square 363 (Madrid) and hotel bar 1264.

While the illustrative embodiment described above uses, as an example, a visit to a museum and a Palace, in other embodiments, systems and methods described herein may be implemented to schedule (and include in an itinerary) any type of activity that a user may engage in while taking a trip, such as attending a sporting event, taking a boat ride, participating in a tour, visiting a restaurant, attending a theater production, taking a balloon ride, etc.

For the purposes of convenience and illustration, many of the embodiments described herein are described in a relatively straightforward narrative fashion in which a user makes one selection after another from the beginning to the end of the process of creating an itinerary, without changing his/her mind and/or making any corrections, changes, etc. However, in another embodiment, features and selections are included that enable a user to return to a previous selection and change the selection, adjust any departure or arrival time, adjust durations, change locations that have already been selected, modify transportation selections, and change or adjust any other component of an itinerary. Advantageously, the ability to make such modifications and adjustments provide a high degree of flexibility to the system and provide convenience to the user.

In another embodiment, an itinerary may be saved at an intermediate stage of completion for later completion, review and/or modification. For example, trip manager 135 may save a partially completed itinerary in storage 230 at the request of a user. At a later time, the user may again access the partially completed itinerary and further create/adjust the itinerary.

In another embodiment, a user may create an itinerary and share the itinerary with one or more different users. For example, a first user employing user device 160-A may create and store an itinerary. Trip manager 135 may then associate a password with the stored itinerary. The first user may then share the password with other users. For example, the first user may share the password with a second user employing user device 160-B. When the second user, employing user device 160-B, accesses trip manager 135 and provides the password, trip manager 135 provides to the second user access to the itinerary.

In another embodiment, multiple users may use the systems and methods described herein to collaboratively construct and maintain an itinerary. Trip manager 135 may receive instructions relating to a single itinerary from a plurality of user devices. For example, in another embodiment similar to the illustrative embodiment discussed above, instructions to add location element 418 (London) may be received from a first user employing user device 160-A, and instructions to add location element 432 (Madrid) may be received from a second user employing user device 160-B.

In various embodiments, the method steps described herein, including the method steps described in FIGS. 5A, 5B, 5C, 5D, 6, 7, and/or 8, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transit it requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 5A, 5B, 5C, 5D, 6, 7, and/or 8, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

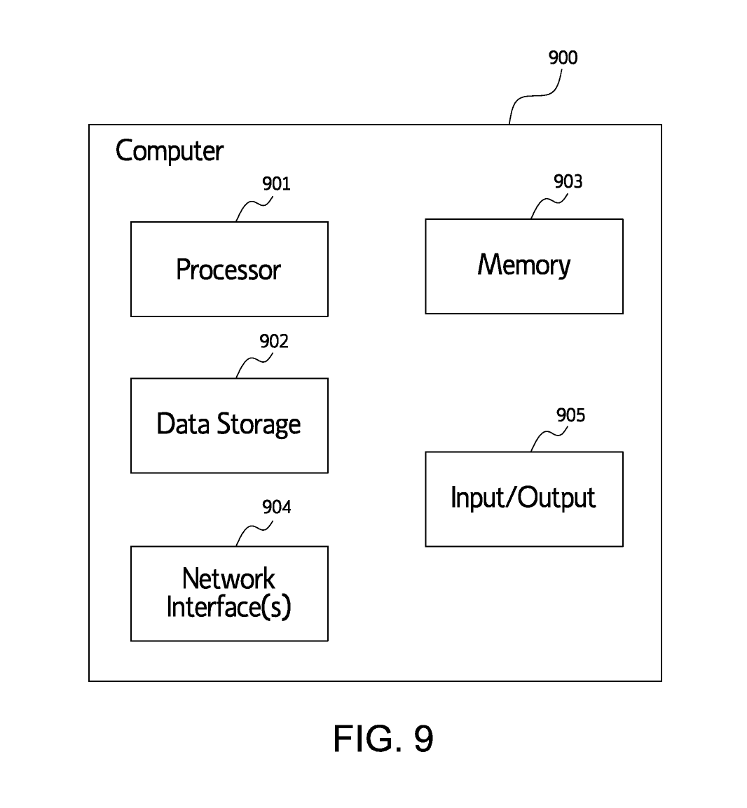

A high-level block diagram of an exemplary computer that may be used to implement systems, apparatus and methods described herein is illustrated in FIG. 9. Computer 900 includes a processor 901 operatively coupled to, a data storage device 902 and a memory 903. Processor 901 controls the overall operation of computer 900 by executing computer program instructions that define such operations. The computer program instructions may be stored in data storage device 902, or other computer readable medium, and loaded into memory 903 when execution of the computer program instructions is desired. Thus, the method steps of FIGS. 5A, 5B, SC, 5D, 6, 7, and/or 8 can be defined by the computer program instructions stored in memory 903 and/or data storage device 902 and controlled by the processor 901 executing the computer program instructions. For example, the computer program instructions can be implemented as computer executable code programmed by one skilled in the art to perform an algorithm defined by the method steps of FIGS. 5A, 5B, 5C, 5D, 6, 7, and/or 8. Accordingly, by executing the computer program instructions, the processor 901 executes an algorithm defined by the method steps of FIGS. 5A, SB, 5C, 5D, 6, 7, and/or 8. Computer 900 also includes one or more network interfaces 904 for communicating with other devices network. Computer 900 also includes one or more input/output devices 905 that enable user interaction r with computer 900 (e.g., display, keyboard, mouse, speakers, buttons, etc.).

Processor 901 may include both general and special purpose microprocessors, and may be the sole processor or one of multiple processors of computer 900. Processor 901 may include one or more central processing units (CPUs), for example. Processor 901 data storage device 902, and/or memory 903 may include, be supplemented by, or incorporated in, one or more application-specific integrated circuits (ASICs) and/or one or more field programmable gate arrays (FPGAs).

Data storage device 902 and memory 903 each include a tangible non-transitory computer readable storage medium. Data storage device 902, and memory 903, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 905 may include peripherals, such as a printer, scanner, display screen, etc. For example, input/output devices 905 may include a display device such as a cathode ray tube (CRT) or liquid crystal display (LCD) monitor for displaying information to the user, a keyboard, and a pointing device such as a mouse or a trackball by which the user can provide input to computer 900.

Any or all of the systems and apparatus discussed herein, including trip manager 135 and user devices 160, and components thereof, including processor 210, memory 220, storage 230, itinerary module 275, calculation module 285, flight reservation module 277, and hotel reservation module 279, may be implemented using a computer such as computer 900.

One skilled in the art will recognize that an implementation of an actual computer or computer system may have other structures and may contain other components as well and that FIG. 9 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of managing an itinerary for a trip, the method comprising:
receiving, by a processor, from a user information indicating a first location at which a traveler is to start the trip, a second location at which the traveler is to end the trip, a start date on which the trip is to begin, a plurality of intermediate locations which the traveler is to visit during the trip, an order in which the intermediate locations are to be visited, and a plurality of intermediate location durations indicating how many nights the traveler is to spend in each respective intermediate location, without receiving from the user dates associated with the intermediate locations;
generating, by the processor, an itinerary comprising a start element associated with the first location, the start element comprising a dateout value, and an end element associated with the second location, the end element comprising a datein value;
for each intermediate location, generating a respective intermediate element comprising a datein value indicating a date when the user is to arrive at the corresponding location, a dateout value indicating a date when the user is to depart from the corresponding location, and a duration value indicating how many nights the user is to spend at the corresponding location;
receiving a plurality of modifications to the itinerary from one or more users; and
for each modification, examining the intermediate elements in succession and performing a series of operations with respect to each respective intermediate element, the series of operations comprising:
updating the datein value of the respective intermediate element based on the dateout value of a preceding element, wherein the start element precedes a first intermediate element and
updating the dateout value of the respective intermediate element based on the duration value of the respective element.

2. The method of claim 1, wherein the plurality of modifications comprise one of a change to a duration value of a selected intermediate element, a removal of a selected intermediate element, and an addition of a second intermediate element.

3. The method of claim 1, further comprising:
generating the trip itinerary comprising the start element, the end element and the plurality of intermediate elements; and
storing the trip itinerary in a memory.

4. The method of claim 3, further comprising:
displaying the trip itinerary visually on a display.

5. The method of claim 1, wherein each of the start element and the end element, and each intermediate element is an object in an object-oriented programming architecture.

6. The method of claim 1, further comprising:
receiving second information relating to a transport component associated with the trip;
generating a transport element associated with the transport component, the transport element comprising a datein value, a dateout value, and a duration value;
generating a transport itinerary comprising a second plurality of location elements corresponding to the intermediate elements, and the transport element; and
adjusting a duration value and a datein value of a location element based on the duration value of the transport element.

7. The method of claim 1, wherein the plurality of modifications comprise a first modification and a second modification,
the method further comprising:
receiving a first modification from a first user device via a network; and
receiving a second modification from a second User device, via the network.

8. A system comprising:
a memory for storing start elements, end elements and intermediate elements in one or more itineraries; and
one or more processors adapted to:
receive from a user information indicating a first location at which a traveler is to start the trip, a second location at which the traveler is to end the trip, a start date on which the trip is to begin, a plurality of intermediate locations which the traveler is to visit during the trip, an order in which the intermediate locations are to be visited, and a plurality of intermediate location durations indicating how many nights the traveler is to spend in each respective intermediate location, without receiving from the user dates associated with the intermediate locations;
generate an itinerary comprising a start element associated with the first location, the start element comprising a dateout value, and an end element associated with the second location, the end element comprising a datein value;
for each intermediate location, generate a respective intermediate element comprising a datein value indicating a date when the user is to arrive at the corresponding location, a dateout value indicating a date when the user is to depart from the corresponding location, and a duration value indicating how many nights the user is to spend at the corresponding location;
receive a plurality of modifications to the itinerary from one or more users; and
for each modification, examine the intermediate elements in succession and performing a series of operations with respect to each respective intermediate element, the series of operations comprising:
updating the datein value of the respective intermediate element based on the dateout value of a preceding element, wherein the start element precedes a first intermediate element; and
updating the dateout value of the respective intermediate element based on the duration value of the respective element.

9. The system of claim 8, wherein the plurality of modifications comprise one of a change to a duration value of a selected intermediate element, a removal of a selected intermediate element, and an addition of a second intermediate element.

10. The system of claim 8, wherein the one or more processors are further adapted to
generate the itinerary comprising the start element, the end element and the plurality of intermediate elements; and
store the itinerary in the memory.

11. The system of claim 8, wherein the one or more processors are further adapted to:
display the trip itinerary visually on a display of a user device.

12. The system of claim 8, wherein each of the start element and the end element, and each intermediate element is an object in an object-oriented programming architecture.

13. The system of claim 8, wherein the one or more processors are further adapted to:
receive second information relating to a transport component associated with the trip;
generate a transport element associated with the transport component, the transport element comprising a datein value, a dateout value, and a duration value;
generate a transport itinerary comprising, a second plurality of location elements corresponding to the intermediate elements, and the transport element; and
adjust a duration value and a datein value of a location element based on the duration value of the transport element.

14. The system of claim 8, wherein the plurality of modifications comprise a first modification and a second modification,
wherein the one or more processors are further adapted to:
receive a first modification from a first user device via a network; and
receive a second modification from a second user device, via the network.

15. A method of managing an itinerary, the method comprising;
maintaining a first itinerary comprising a first plurality of first location elements associated with locations to be visited during a trip, each first location element comprising first duration information, first datein information, and first dateout information;
maintaining a second itinerary comprising a plurality of transport elements associated with transportation to be used during the trip and a second plurality of second location elements, each second location element associated with a corresponding first location element, each second location element comprising second duration information, second datein information, and second dateout information;
receiving modification information indicating that a duration specified in a selected first location element has been altered;
adjusting one of first duration, first datein information, and first dateout information in one or more first location elements based on the modification information;
receiving flight information relating to an airline flight to be taken during the trip; and
adjusting one of a second duration information and a second datein information in a second location element based on the flight information.

16. The method of claim 15, wherein the first itinerary further comprises:
a start element including a duration field having a NULL value, a datein field having a NULL value, and a dateout field having a dateout value corresponding to a first value stored in a datein field of a subsequent location element;
an end element including a duration field having a NULL value, a datein field having a datein value corresponding to a second value stored in a datein field of a previous location element, and a dateout field having a NULL value.

17. The method of claim 15, wherein the transportation comprises one of an airline flight, a train ride, a boat ride, a ferry ride, a car ride, and a bus ride.

18. The method of claim 15, further comprising:
maintaining a third itinerary comprising a plurality of local elements associated with local hotels and local events scheduled during the trip.

19. The method of claim 18, further comprising:
displaying the first itinerary, the second itinerary, and the third itinerary on a display.
